(19) United States
(12) Patent Application Publication
(10) Pub. No.: US 2016/0196085 A1
(43) Pub. Date: Jul. 7, 2016

(54) STORAGE CONTROL APPARATUS AND STORAGE APPARATUS

(71) Applicant: FUJITSU LIMITED, Kawasaki-shi (JP)

(72) Inventor: Kiyoto Minamiura, Koto (JP)

(73) Assignee: FUJITSU LIMITED, Kawasaki-shi (JP)

(21) Appl. No.: 14/968,968

(22) Filed: Dec. 15, 2015

(30) Foreign Application Priority Data
Jan. 5, 2015 (JP) 2015-000281

(51) Int. Cl. G06F 3/06

(52) U.S. Cl. CPC G06F 3/0625; G06F 3/0619; G06F 3/0659; G06F 3/065; G06F 3/0683

(57) ABSTRACT

Storage resources are used to store backup data and are normally turned off. When a write request for backup data into a storage resource has been received, a control unit stores the backup data in a storage unit so as to be associated with the storage resource. The control unit turns on the power of a storage resource at predetermined timing. The control unit reads the backup data associated with the storage resource whose power has been turned on from the storage unit and writes the backup data into the storage resource. The control unit then turns off the power of the storage resource for which the write has been completed.

### CROSS-REFERENCE TO RELATED APPLICATION

This application is based upon and claims the benefit of priority of the prior Japanese Patent Application No. 2015-000281, filed on Jan. 5, 2015, the entire contents of which are incorporated herein by reference.

### FIELD

The present embodiments discussed herein are related to a storage control apparatus and a storage apparatus.

### BACKGROUND

At present, data is stored using storage apparatuses equipped with a plurality of storage resources, such as hard disk drives (HDDs) and solid state drives (SSDs), so as to provide large-capacity storage regions. As one example configuration, a storage apparatus is connected to a controller that performs access control over the storage resources. A controller may also be incorporated in a storage apparatus. The controller receives access requests from a host computer and controls reads and writes of data to and from the respective storage resources.

As one example, a technology has been proposed where a plurality of controllers are provided to spread the load of a single controller. With this technology, two controllers are each provided with a cache mechanism. A high reliability mode where the same data is stored in both cache memory systems, a high performance mode where data is independently stored in the two cache memory systems, and an averaged mode that is a compromise between reliability and performance are also provided so that a disk cache function can be optimized according to the application.

Various attempts have been made to reduce the power consumed in driving storage resources. As one example, a configuration has been proposed where power consumption is reduced for a local disk provided in a computer system with a disk cache. According to this configuration, the disk cache is flashed when a predetermined period has passed from the previous flashing, when a predetermined period has passed from the previous disk access, or when the number of a disk accesses has reached a predetermined value. When a predetermined time has passed from the last disk access, the rotary motor of one local disk is stopped.

See, for example, the following documents: Japanese Laid-Open Patent Publication No. 07-110788; and Japanese Laid-Open Patent Publication No. 09-44314.

To guard against damage to data and data loss, it is customary to create a copy of data as a backup. The data (referred to as “backup data”) generated by a backup process may be stored in a plurality of storage resources inside a storage apparatus. When doing so, there is room for improvement regarding the power consumption of the storage apparatus.

As one example, it would be conceivable to turn off the power to all of the storage resources inside a storage apparatus and to turn on all of the storage resources at once only during a write. However, when a plurality of storage resources are turned on at once, there is the risk of power being turned on for storage resources for which there is no data to be written, resulting in power being wastefully consumed by such storage resources. In particular, the write frequency for a storage apparatus by a backup process is low compared to everyday job processing. This means that when the power is turned on for a plurality of storage resources at once, there is a high probability of storage resources for storing backup data being unnecessarily turned on and wastefully consuming power.

### SUMMARY

According to one aspect there is provided a storage control apparatus including: a memory that stores backup data that has a plurality of storage resources, which are used to store the backup data and whose power can be individually turned on and off, as write destinations; and a processor that performs a control procedure including: storing, whenever a write request for backup data for a storage resource out of the plurality of storage resources has been received while the power of the storage resource is off, the backup data in the memory so as to be associated with the storage resource; separately turning on, at predetermined timing, the power of one or more storage resources that are the write destinations of the backup data stored in the memory, out of the plurality of storage resources; reading the backup data associated with the one or more storage resources whose power has been turned on from the memory and writing the backup data into the one or more storage resources; and turning off the power of the one or more storage resources for which the writing has been completed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts a storage control apparatus according to a first embodiment;

FIG. 2 depicts an information processing system according to a second embodiment;

FIG. 3 depicts example hardware of a storage apparatus;

FIG. 4 depicts example hardware of a management apparatus;

FIG. 5 depicts example functions of a storage apparatus;

FIG. 6 depicts an example of correspondence between logical volumes and an aggregate/RAID;

FIG. 7 depicts an example of correspondence between the logical volumes and buffers;

FIG. 8 depicts an example of a logical volume management table;

FIG. 9 depicts an example of a disk management table;

FIG. 10 depicts an example of backup setting information;

FIG. 11 depicts an example of a disk power management table;

FIG. 12 depicts examples of buffers;

FIG. 13 is a flowchart depicting an example of a power-on process;

FIG. 14 is a flowchart depicting an example of a disk failure process;

FIG. 15 is a flowchart depicting an example of a backup data writing process;

FIGS. 16A and 16B depict examples of correspondence between logical volumes and HDDs; and

FIG. 17 depicts example hardware of a storage control apparatus according to a third embodiment.

### DESCRIPTION OF EMBODIMENTS

Several embodiments will be described below with reference to the accompanying drawings, wherein like reference numerals refer to like elements throughout.

### First Embodiment

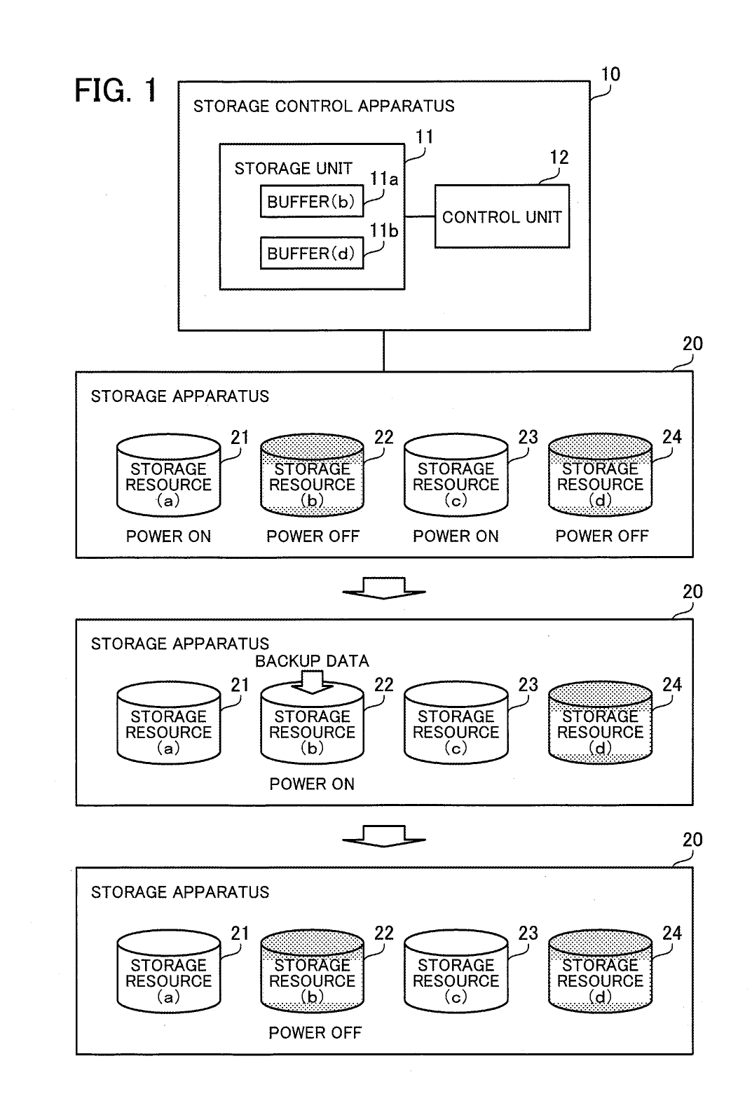

FIG. 1 depicts a storage control apparatus according to a first embodiment. A storage control apparatus 10 is connected to a storage apparatus 20. The storage apparatus 20 houses a plurality of storage resources 21, 22, 23, and 24 such as HDDs and/or SSDs. The storage control apparatus 10 controls reads and writes of data from and into the plurality of storage resources. The storage control apparatus 10 is also referred to as a “controller”. The storage control apparatus 10 may be incorporated in the storage apparatus 20.

The storage control apparatus 10 is connected for example to a network (not illustrated). Other storage control apparatuses, which control other storage apparatuses, and various apparatuses such as a server computer and a client computer are connected to the network. The storage control apparatus 10 receives requests for writes and reads of data into and from the storage apparatus 20 from other apparatuses connected to the network. In accordance with a request, the storage control apparatus 10 writes data into any of the storage resources of the storage apparatus 20 or reads data from any of the storage resources of the storage apparatus 20. The storage control apparatus 10 provides the result of a write or read of data in reply to the apparatus that issued the request.

Here, the storage resources 21 and 23 are used to store data handled in job processing. The storage resources 22 and 24 are used to store backup data acquired for data handled in the job processing. The data is stored in the storage resources 22 and 24 is a backup and is not directly updated along with execution of the job processing. As one example, the backup data is created by another storage control apparatus and is transmitted to the storage control apparatus 10. It is also possible for the backup data to be created by a server computer, a client computer, or the like and then transmitted to the storage control apparatus 10. Note that identification information is assigned to the storage resources 21, 22, 23, and 24. The identification information of the storage resource 21 is “a”, the identification information of the storage resource 22 is “b”, the identification information of the storage resource 23 is “c”, and the identification information of the storage resource 24 is “d”. It is possible to perform on and off control of power separately for the storage resources 21, 22, 23, and 24.

The storage control apparatus 10 includes a storage unit 11 and a control unit 12. The storage unit 11 may be a volatile storage resource, such as random access memory (RAM), or may be a nonvolatile storage resource, such as an HDD or flash memory. However, as described later, the storage unit 11 is used as a buffer that temporarily stores backup data and for this reason, it is preferable for the storage unit 11 to be a nonvolatile storage resource. This is to protect against loss of the stored data due to an unexpected power failure of the storage control apparatus 10. The control unit 12 may include a central processing unit (CPU), a digital signal processor (DSP), an application specific integrated circuit (ASIC), a field programmable gate array (FPGA), or the like. The control unit 12 may be a processor that executes a program. The expression “processor” here may include a combination of a plurality of processors (i.e., a so-called “multiprocessor”).

The storage unit 11 includes buffers 11a and 11b for temporarily storing backup data to be stored in the storage resources 22 and 24, respectively. The buffer 11a is a storage region for storing backup data for which a write into the storage resource 22 has been requested. The buffer 11b is a storage region for storing backup data for which a write into the storage resource 24 has been requested.

As one example, a range of addresses equivalent to the buffer 11a is reserved in advance in the storage unit 11 so as to be associated with the storage resource 22. As one example, the control unit 12 manages a first range of addresses of the storage unit 11 so as to be associated with the identification information “b” of the storage resource 22. Here, the storage resource that corresponds to the first range of addresses is the buffer 11a. In the same way, the control unit 12 manages a second range of addresses of the storage unit 11 so as to be associated with the identification information “d” of the storage resource 24. Here, the storage region that corresponds to the second range of addresses is the buffer 11b. Alternatively, backup data that is to be written into the storage resource 22 may be stored in the storage unit 11 having been appended (by the control unit 12, for example) with identification information “b” of the storage resource 22. With this configuration, a group of storage regions in which backup data assigned with the identification information “b” of the storage resource 22 is stored can be regarded as “the buffer 11a”. The buffer 11b is the same as the buffer 11a.

The control unit 12 normally keeps the power of the storage resources 22 and 24 for storing the backup data off. As one example, when the storage apparatus 20 starts up and the power is turned on for the storage resources 21, 22, 23, and 24 in the storage apparatus 20, the control unit 12 carries out recognition for the storage resources 21, 22, 23, and 24. The control unit 12 then turns off the power of the storage resources 22 and 24 that are used to store backup data. Information indicating the storage resources used to store the backup data is stored in advance in one of the storage resources of the storage apparatus 20. By referring to such information, the control unit 12 determines whether any of the storage resources are used for storing backup data.

Upon receiving a write request for backup data into either storage resource out of the storage resources 22 and 24 whose power has been turned off, the control unit 12 stores the backup data in the storage unit 11 so as to be associated with the storage resource that is the write destination. As one example, the control unit 12 receives a write request for backup data from another storage control apparatus, a client computer, or the like that is connected to the network. A write request includes information (for example, information on a volume name) for specifying the storage resource that is the write destination. The control unit 12 is also capable of determining that data to be written is backup data when the write destination of the data is either of the storage resources 22 and 24.

As one example, the control unit 12 receives a write request for backup data into the storage resource 22. In response, the control unit 12 stores the backup data in the buffer 11a corresponding to the storage resource 22. That is, the control unit 12 merges backup data whose write destination is the storage resource 22 inside the buffer 11a.

By doing so, it is possible to manage the backup data in the buffers with the backup data aggregated into units of storage resources. When the backup data in file units is stored so as to be distributed between storage resources, it is possible to manage the backup data on a storage resource basis in the buffers. By doing so, it becomes possible to carry out write control on a storage resource basis and to realize on/off control of the power of individual storage resources.

At predetermined timing, the control unit 12 turns the power on for some of the storage resources (for example, the storage resource 22) out of the storage resources 22 and 24. The control unit 12 reads the backup data associated with the storage resource whose power has been turned on from the storage unit 11 and writes the backup data into the storage resource in question. When the write has been completed, the control unit 12 turns the power of the storage resource off.

A variety of timing can be used as the predetermined timing. A first example is timing at which the total size of the backup data stored in the buffer corresponding to a given storage resource becomes equal to or above a threshold (i.e., a “buffer full” state). As one example, when the buffer full state has been detected for the buffer 11a, the control unit 12 turns on the power of the storage resource 22 corresponding to the buffer 11a.

A second example is timing when a period set in advance has elapsed following the timing at which backup data was stored in a given buffer. As one example, when it is detected that backup data has been stored in the buffer 11a for a period set in advance, the control unit turns on the power of the storage resource 22 corresponding to the buffer 11a.

A third example is timing at which a write instruction given by the user is received. As examples, when an instruction for a write of backup data from the buffer 11a or an instruction for a write of backup data into the storage resource 22 has been received from the user, the control unit 12 turns on the power of the storage resource 22 corresponding to the buffer 11a.

Once the power of the storage resource 22 has been turned on at any of the timing given above, the control unit 12 writes the backup data stored in the buffer 11a into the storage resource 22. The control unit 12 then turns off the power of the storage resource 22 for which the write has been completed. The control unit 12 also makes it possible to reuse the buffer 11a, such as by making it possible to overwrite the information stored in the buffer 11a.

With the storage control apparatus 10, when a write request for backup data into the storage resource 22 has been received by the control unit 12, backup data is stored into the storage unit 11 so as to be associated with the storage resource 22. The control unit 12 turns on the power of the storage resource 22 out of the storage resources 22 and 24 at predetermined timing. The control unit 12 reads the backup data associated with the storage resource 22 from the storage unit 11 and writes the backup data into the storage resource 22. The power of the storage resource 22 for which the write has been completed is then turned off by the control unit 12. This makes it possible to reduce the power consumption of the storage apparatus 20.

Here, it is also conceivable to reduce power consumption by turning the power of all the storage resources 21, 22, 23, and 24 inside the storage apparatus 20 on and off at once. However, when the power is also turned on for storage resources for which there is no data to be written, power is wastefully consumed at such storage resources. In particular, the write frequency of backup processing is low compared to everyday job processing. This means that when the power of the storage resources 22 and 24 is turned on at once, there is a high probability of storage resources for which there is no data to be written also being turned on and power being wastefully consumed by such storage resources.

For the reason given above, the storage control apparatus 10 normally keeps the power off for the storage resources 22 and 24 used to store the backup data, and buffers backup data so as to be associated with such storage apparatuses. The storage control apparatus 10 intermittently turns on the power of one or both of the storage resources 22 and 24 and writes the backup data corresponding to the storage resources whose power has been turned on into such storage resources. By doing so, it is possible to make the periods for which the power is off for the respective storage resources 22 and 24 longer than with a configuration where the power of the storage resources 22 and 24 is turned on at once. In other words, it is possible to reduce the periods for which the power of the respective storage resources 22 and 24 is on. It is therefore possible to reduce the power consumption of the storage resources 22 and 24 and reduce overall power consumption.

As one example, it would be conceivable to omit the buffers 11a and 11b and to turn on the power of the storage resources 22 and 24 when a start of transfer of backup data is detected. However, the power of the storage resources 22 and 24 would be repeatedly turned on and off every time backup data is transferred, resulting in an increased risk of damage to the storage resources 22 and 24 due to inrush currents. By aggregating the backup data in the buffers 11a, 11b until a collective write of a certain amount of data is possible and then storing in the storage resources 22 and 24, it is possible to reduce the probability of the power of the storage resources 22 and 24 being frequently turned on and off and thereby reduce the risk of damage to the storage resources 22 and 24.

When the buffers 11a and 11b are omitted and the backup schedules of a plurality of transfer sources of backup data overlap, there are cases where the periods for which the power of the storage resources 22 and 24 is off are comparatively short, or where the power is not actually turned off (i.e., a condition for turning off the power does not become satisfied). By buffering the backup data, it is possible, even when the backup schedules overlap, to extend the periods for which the power of the storage resources 22 and 24 is off until a buffer becomes full.

Since the backup data can be held using the buffers 11a and 11b at the start of a backup operation without the storage resources 22 and 24 starting up, it is not necessary to wait for the storage resources 22 and 24 to start up at the start of a backup operation. Accordingly, it is possible to avoid a drop in response at the start of backup due to the lead time when the storage resources 22 and 24 start up.

In addition, writes of data occur more frequently for the storage resources 21 and 23 for everyday jobs than for the storage resources 22 and 24. Accordingly, if buffers were also provided as described above for the storage resources 21 and 23, there would be a high probability of a “buffer full” state being reached in a short time compared to the storage resources 22 and 24. There would also be the risk of the power of the storage resources 21 and 23 being frequently turned on and off, resulting in the risk of damage to the storage resources 21 and 23 due to inrush currents. This means that by providing the buffers for the storage resources 22 and 24 used to store backup data and turning the power on and off individually as described above, it is possible to reduce power consumption efficiently.

Note that the storage control apparatus 10 may be equipped with a plurality of buffers (by using a two-sided configuration, for example) for a single storage resource. As one example, a spare buffer may be provided for the storage resource 22 in addition to the buffer 11a. By using this configuration, the storage control apparatus 10 is capable of using the spare buffer to store additional backup data which is to be written into the storage resource 22 and is received from a transfer source apparatus during a write of backup data from the buffer 11a into the storage resource 22. By doing so, it is possible to prevent interruptions to the backup process at the transfer source of the backup data and thereby carry out the backup process efficiently.

It is also possible to improve the data access performance of the storage control apparatus 10 and the reliability against storage resource failures by storing data so as to be distributed among a plurality of storage resources according to a technology called RAID (Redundant Arrays of Independent Disks. When RAID is used, it is possible to define storage resources for storing backup data in units of storage resource groups that form a RAID (i.e., “RAID groups”). As one example, when a given RAID group is chosen to store backup data, all of the storage resources belonging to such RAID group are treated as storing backup data. By providing a buffer in the storage unit 11 for each storage resource belonging to a RAID, it is possible for the control unit 12 to perform write control in the same way as described above to reduce the power consumption of the storage apparatus 20.

### Second Embodiment

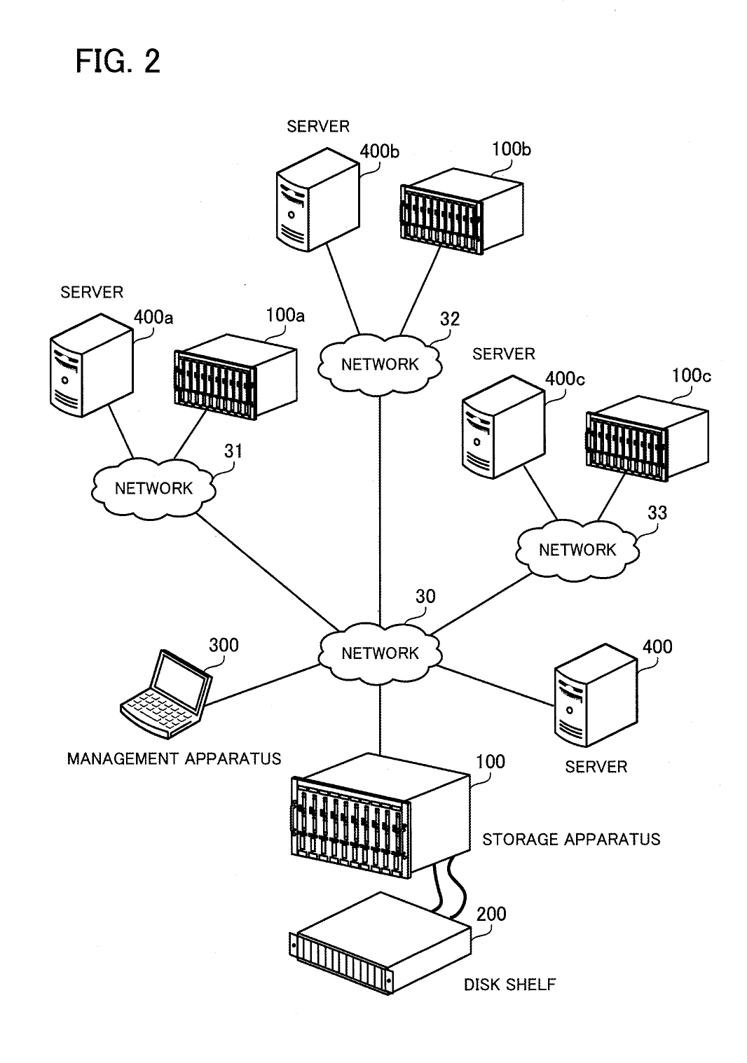

FIG. 2 depicts an information processing system according to a second embodiment. The information processing system according to the second embodiment includes storage apparatuses 100, 100a, 100b, and 100c, a disk shelf 200, a management apparatus 300, and servers 400, 400a, 400b, and 400c. The storage apparatus 100, the management apparatus 300, and the server 400 are connected to a network 30. The storage apparatus 100a and the server 400a are connected to a network 31. The storage apparatus 100b and the server 400b are connected to a network 32. The storage apparatus 100c and the server 400c are connected to a network 33. The disk shelf 200 is connected to the storage apparatus 100.

As one example, the networks 30, 31, 32, and 33 are local area networks (LAN). The networks 31, 32, and 33 are connected to the network 30. The networks 30, 31, 32, and 33 may be connected via the Internet.

The storage apparatuses 100, 100a, 100b, and 100c are equipped with a plurality of HDDs (and/or SSDs). Writes and reads of data to or from storage resources provided in the storage apparatuses 100, 100a, 100b, and 100c are performed via the networks. The storage apparatuses 100, 100a, 100b, and 100c form a RAID using a plurality of HDDs, but also include HDDs that do not form a RAID.

The storage apparatus 100 stores data used in processing by the server 400. The storage apparatus 100 receives requests for data writes and reads from the server 400 via the network 30. The storage apparatus 100 also sends the results of data writes and reads in reply via the network 30 to the server 400 that issued the requests.

The storage apparatus 100 also receives write requests for backup data from the storage apparatuses 100a, 100b, and 100c. A write request for backup data includes backup data and information specifying the write destination of the backup data (for example, a volume name of a write destination). The storage apparatus 100 writes the backup data into an HDD in accordance with the write request. As described later, on receiving a write request for backup data, the storage apparatus 100 accumulates the backup data in a buffer. When the amount of data accumulated in the buffer reaches a certain size, the storage apparatus 100 writes the backup data stored in the buffer into an HDD.

The disk shelf 200 houses a plurality of HDDs (and/or SSDs). The disk shelf 200 is connected by a predetermined cable to the storage apparatus 100. The storage apparatus 100 also controls access to the HDDs housed in the disk shelf 200. The storage apparatus 100 is capable of constructing a RAID using the HDDs housed in the storage apparatus 100 and the HDDs housed in the disk shelf 200. The storage apparatuses 100a, 100b, and 100c may also be connected to a disk shelf in the same way.

Storage apparatuses, like the storage apparatuses 100, 100a, 100b, and 100c, that are connected to and used via a network are referred to as NAS (Network Attached Storage). The storage apparatus 100 has a function for acquiring backup data for data stored in the storage apparatuses 100a, 100b, and 100c. The storage apparatus 100 acquires backup data for the data stored in the storage apparatuses 100a, 100b, and 100c from the storage apparatuses 100a, 100b, and 100c and stores the backup data in predetermined HDDs in the storage apparatus 100.

The management apparatus 300 is a client computer used to set the storage apparatus 100. As one example, a manager of the system operates the management apparatus 300 to make various settings of the storage apparatus 100. As specific examples, the manager makes settings of a schedule of backup processing by the storage apparatus 100 and the storage destinations of backup data.

The servers 400, 400a, 400b, and 400c are server computers that execute software for user jobs. The servers 400, 400a, 400b, and 400c are used by different users in respectively different regions.

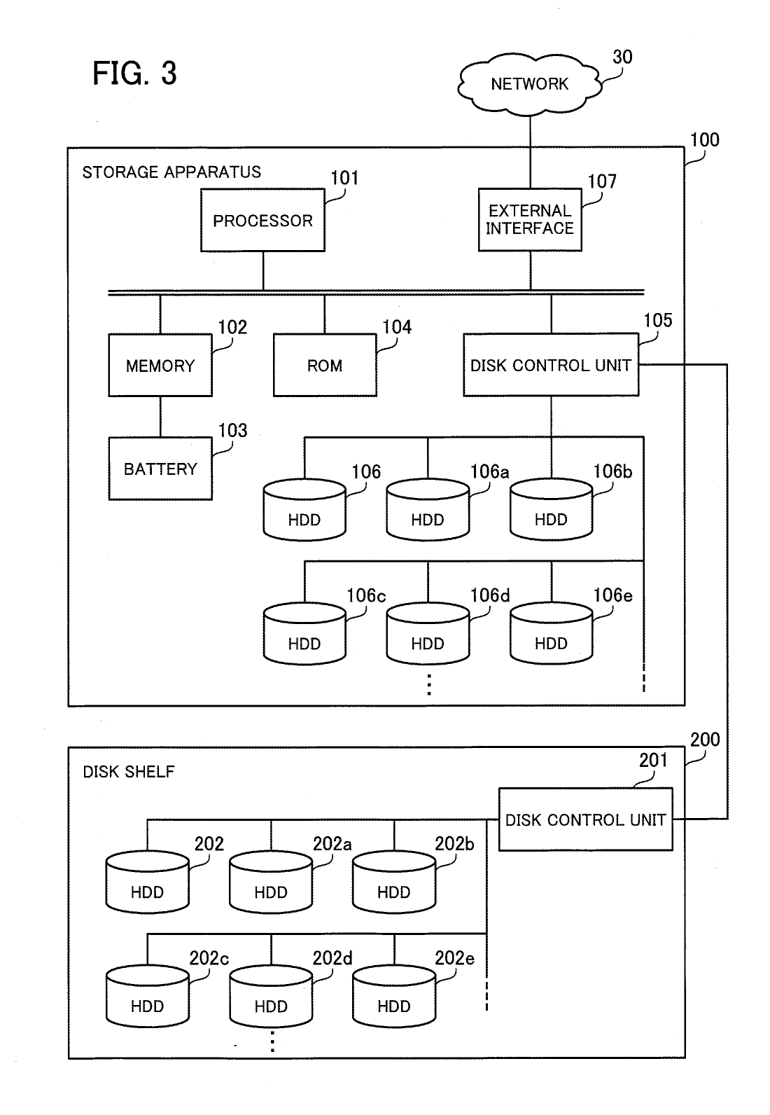

FIG. 3 depicts example hardware of a storage apparatus. The storage apparatus 100 includes a processor 101, a memory 102, a battery 103, a ROM (Read Only Memory) 104, a disk control unit 105, HDDs 106, 106a, 106b, 106c, 106d, 106e . . . and an external interface 107. The respective units are connected to a bus of the storage apparatus 100.

The processor 101 controls information processing of the storage apparatus 100. The processor 101 may be a multiprocessor. As examples, the processor 101 is a CPU, a DSP, an ASIC, or an FPGA. The processor 101 may also be a combination of two or more of a CPU, a DSP, an ASIC, or an FPGA.

The memory 102 is main storage of the storage apparatus 100. The memory 102 temporarily stores at least part of an operating system (OS, management OS of the storage apparatus 100) program and an application program to be executed by the processor 101. The memory 102 also stores various data used in processing by the processor 101. The memory 102 is non-volatile RAM (NVRAM) that is backed up by the battery 103.

The battery 103 is a cell that supplies power to the memory 102.

The ROM 104 stores management OS programs, application programs, and various data. The ROM 104 may be a rewritable memory.

The disk control unit 105 performs writes of data into the HDDs provided in the storage apparatus 100 and reads of data from the HDDs in accordance with instructions from the processor 101. The disk control unit 105 is also connected to the disk shelf 200 using a predetermined cable. The disk control unit 105 may also transmit instructions from the processor 101 to the disk shelf 200. The disk control unit 105 turns the power of individual HDDs on and off in accordance with instructions from the processor 101. As one example, it is possible to use SAS (Serial Attached SCSI, where SCSI is an abbreviation of Small Computer System Interface) as the interface of the disk control unit 105. The disk control unit 105 includes a plurality of adapters for connecting to internal HDDs, external disk shelves, and cables.

The HDDs 106, 106a, 106b, 106c, 106d, 106e . . . are HDDs provided in the storage apparatus 100. The HDDs magnetically read and write data from and onto internally housed magnetic disks. The HDDs store various data used for job processing by the server 400. In place of the HDDs or in addition to the HDDs, the storage apparatus 100 may be equipped with other types of storage resource, such as SSDs.

The external interface 107 is a communication interface for communication with other apparatuses (for example, the server 400, other storage apparatuses, and the management apparatus 300) via the network 30.

The disk shelf 200 includes a disk control unit 201 and HDDs 202, 202a, 202b, 202c, 202d, 202e . . . . The disk control unit 201 is connected to the disk control unit 105 using a predetermined cable. The disk control unit 201 receives instructions given by the processor 101 via the disk control unit 105 and performs writes of data onto the HDDs housed in the disk shelf 200 and reads of data from the HDDs in accordance with the instructions. In the same way as the disk control unit 105, it is possible to use SAS as the interface of the disk control unit 201. The HDDs 202, 202a, 202b, 202c, 202d, 202e . . . are HDDs housed in the disk shelf 200. However, the disk shelf 200 may be equipped with other types of storage resource, such as SSDs, in place of the HDDs or in addition to the HDDs.

Here, a number of the HDDs provided in the storage apparatus 100 and the disk shelf 200 are used to store backup data. In the following description, the HDDs that store backup data are referred to simply as “backup HDDs”.

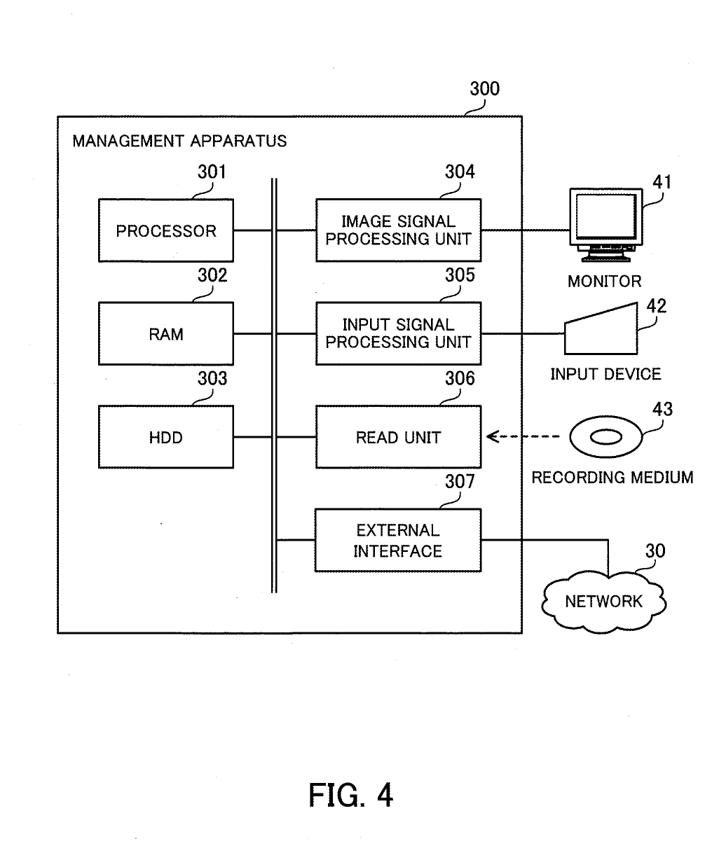

FIG. 4 depicts example hardware of the management apparatus. The management apparatus 300 includes a processor 301, a RAM 302, an HDD 303, an image signal processing unit 304, an input signal processing unit 305, a read unit 306, and an external interface 307. The respective units are connected to the bus of the management apparatus 300. The servers 400, 400a, 400b, and 400c can be realized by the same hardware as the management apparatus 300.

The processor 301 controls information processing of the management apparatus 300. The processor 301 may be a multiprocessor. As examples, the processor 301 is a CPU, a DSP, an ASIC, or an FPGA. The processor 301 may also be a combination of two or more of a CPU, a DSP, an ASIC, and an FPGA.

The RAM 302 is main storage of the management apparatus 300. The RAM 302 temporarily stores at least part of an OS program and an application program to be executed by the processor 301. The RAM 302 also stores various data used in processing by the processor 301.

The HDD 303 is auxiliary storage of the HDD 303. The HDD 303 magnetically reads and writes data from and onto internally housed magnetic disks. OS programs, application programs, and various data are stored in the HDD 303. The management apparatus 300 may be equipped with another type of auxiliary storage resource, such as flash memory or an SSD, or may be equipped with a plurality of auxiliary storage resources.

The image signal processing unit 304 outputs images to a monitor 41 connected to the management apparatus 300 in accordance with instructions from the processor 301. As the monitor 41, it is possible to use a cathode ray tube (CRT) display, a liquid crystal display, or the like.

The input signal processing unit 305 acquires an input signal from an input device 42 connected to the management apparatus 300 and outputs to the processor 301. As examples of the input device 42, it is possible to use a pointing device, such as a mouse, a digitizer, or a touch panel, or a keyboard.

The read apparatus 306 reads programs and data recorded on a recording medium 43. As examples of the recording medium 43, it is possible to use a magnetic disk such as a flexible disk or an HDD, an optical disc such as a compact disc (CD) or a digital versatile disc (DVD), or a magneto-optical (MO) disk. As another example, it is also possible to use a nonvolatile semiconductor memory, such as a flash memory card, as the recording medium 43. In accordance with an instruction from the processor 301, for example, the read apparatus 306 stores a program or data read from the recording medium 43 in the RAM 302 or the HDD 303.

The communication interface 307 communicates with other apparatuses via the network 30. The external interface 307 may be an interface for wired communication or for wireless communication.

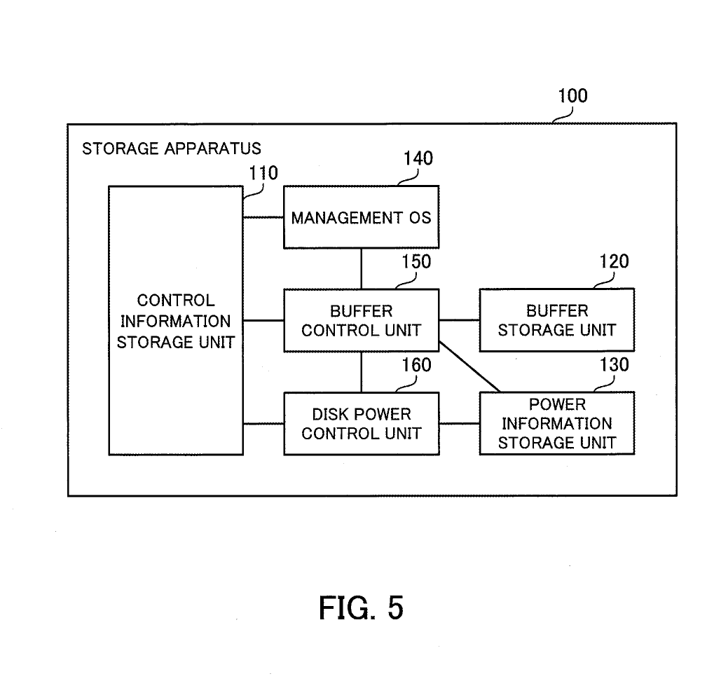

FIG. 5 depicts example functions of a storage apparatus. The storage apparatus 100 includes a control information storage unit 110, a buffer storage unit 120, a power information storage unit 130, a management OS 140, a buffer control unit 150, and a disk power control unit 160. The control information storage unit 110 is realized by a storage region (referred to as a “control region”) reserved in one of the HDDs housed in the storage apparatus 100. The buffer storage unit 120 and the power information storage unit 130 are realized by storage regions reserved in the memory 102. The management OS 140, the buffer control unit 150, and the disk power control unit 160 are realized by the processor 101 executing programs.

The control information storage unit 110 stores information on a RAID and/or the HDDs that form a RAID, and information on backup settings. The information on backup settings includes information on the source and storage destination of backup data, the schedule for executing a backup process, and the like.

The buffer storage unit 120 is a storage region that provides a buffer for each backup HDD. Each buffer temporarily stores backup data to be written into a backup HDD that corresponds to the buffer. The buffers are managed by the buffer control unit 150 so as to be associated with the HDDs.

The power information storage unit 130 stores a disk power management table. The disk power management table is used to manage the on/off state of the power of each HDD.

The management OS 140 is an OS for managing the entire storage apparatus 100. The management OS 140 receives write requests for data into the HDDs provided in the storage apparatus 100 or the disk shelf 200 and read requests for data from the HDDs. The management OS 140 performs writes and reads of data to and from the HDDs and sends the results of the writes and reads in reply to the apparatuses that issued the requests.

The buffer control unit 150 controls writes of backup data into the buffers provided in the buffer storage unit 120 and reads of backup data from the buffers. When a write request for backup data into a backup HDD has been received, the buffer control unit 150 stores the backup data in the buffer corresponding to the HDD that is the write destination.

The buffer control unit 150 also controls writes of backup data that has been stored in the buffers into the HDDs. More specifically, at predetermined timing, the buffer control unit 150 instructs the management OS 140 to write the backup data stored in a buffer into the HDD corresponding to the buffer. Three examples of the predetermined timing mentioned here are given below.

A first example is when the buffer corresponding to any of the HDDs has become full. It is possible to determine whether a buffer is full (the “buffer full state”) in accordance with the total size of the backup data stored in the buffer. As one example, the buffer full state is when the total size of the backup data stored in the buffer has reached or exceeded a threshold. The threshold can be set at a data size such as 90% or 100% of the storage capacity of the buffer. Alternatively, the buffer full state may be when the free capacity of the buffer has fallen below a threshold (for example, when the free space is zero or a data size that is 10% of the storage capacity of the buffer). When the buffer full state is reached, the buffer control unit 150 instructs the management OS 140 to write the backup data stored in the buffer that has reached the buffer full state into the backup HDD corresponding to the buffer.

A second example is when the time that has elapsed from when backup data was stored in any of the buffers has reached or exceeded a maximum data holding period. The maximum data holding period is the maximum period for which backup data is held in a buffer, and can be independently decided in advance for each buffer. The buffer control unit 150 separately measures the time that has elapsed since backup data was stored in each buffer. When the elapsed time for any of the buffers has reached the maximum data holding period, the buffer control unit 150 instructs the management OS 140 to write the backup data stored in such buffer into the backup HDD corresponding to the buffer. When the write has been completed, the buffer control unit 150 resets the elapsed time of the timer for such buffer to zero and stops the measurement of time until the next backup data is received.

A third example is timing at which an input indicating that backup data is to be written into a backup HDD is received. As one example, it is possible for the manager of the system to operate a terminal apparatus connected to the network 30 to input information on the buffer that is the source for the write or the backup HDD that is the write destination. On receiving a write instruction from the manager, the buffer control unit 150 instructs the management OS 140 to write the backup data stored in the indicated buffer into the backup HDD corresponding to the buffer.

In this configuration, there is correspondence between the buffers and the backup HDDs. It is therefore possible for the buffer control unit 150 to specify the backup HDD that is the write destination from the buffer information. It is also possible for the buffer control unit 150 to specify the buffer that is the source of a write from information on the backup HDD that is the write destination.

At any of the timing described above, the buffer control unit 150 instructs the management OS 140 to write the backup data stored in a buffer into a backup HDD. When the write of backup data by the management OS 140 has been completed, the buffer control unit 150 deletes the backup data from the buffer that was the source of the write (or enables overwriting) to enable the storage region of the buffer to be reused.

The buffer control unit 150 is provided with two buffers for one backup HDD (referred to here as a “two-sided configuration”). When a write request for backup data is received during a period where the power of a backup HDD is off, the buffer control unit 150 stores the backup data into one of the two buffers. When a write request for a backup HDD is received while backup data is being written from one buffer into the same backup HDD, the other buffer (referred to as the “spare buffer”) is used to store the backup data (referred to as “additional backup data”) of the write request. Once the write of the backup data being written has been completed, the buffer control unit 150 writes the additional backup data stored in the other buffer into the backup HDD. Since the buffer control unit 150 controls writes of backup data into a buffer or HDD, the buffer control unit 150 may be referred to as the “write control unit”.

The disk power control unit 160 uses the disk control unit 105 to perform on/off control of the power of each backup HDD. Here, when the storage apparatus 100 starts up, the power is turned on for all of the HDDs to enable the HDDs to be recognized by the management OS 140. Once all of the HDDs inside the storage apparatus 100 have been recognized by the management OS 140, the disk power control unit 160 turns off the power of the backup HDDs.

When performing a write of backup data from any of the buffers into the backup HDD, the disk power control unit 160 turns on the backup HDD that is the write destination. When the write of the backup data has been completed, the disk power control unit 160 turns off the power of the write destination backup HDD.

Since the disk power control unit 160 and the disk control unit 105 are used for on/off control over the power of HDDs, the disk power control unit 160 or the disk control unit 105 may be referred to as the “power control unit”. When the disk control unit 105 is referred to as the power control unit, the processor 101 may be referred to as the “write control unit”.

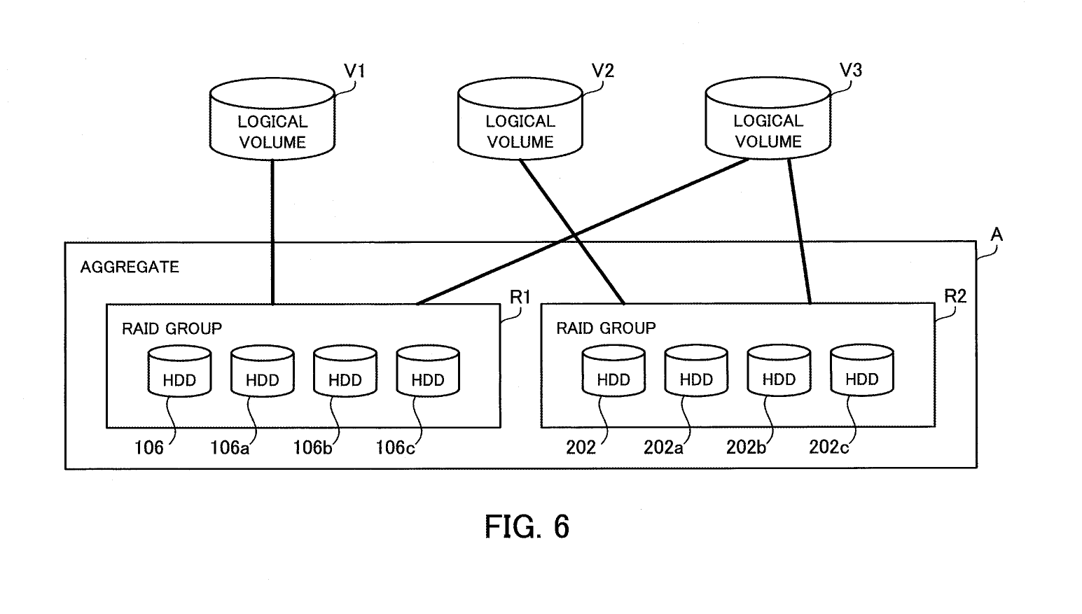

FIG. 6 depicts an example of correspondence between logical volumes and an aggregate/RAID. The storage apparatus 100 manages the plurality of HDDs managed by the storage apparatus 100 as a group of disk resources called an “aggregate”. The storage apparatus 100 may create a plurality of aggregates. The aggregate A is one aggregate managed by the storage apparatus 100.

The aggregate A includes RAID groups R1 and R2. Four HDDs belong to each of the RAID groups R1 and R2 (although a number of HDDs aside from four may form a RAID). More specifically, HDDs 106, 106a, 106b, and 106c belong to the RAID group R1 and HDDs 202, 202a, 202b, and 202c belong to the RAID group R2.

As one example, the storage apparatus 100 reserves a storage region used by software on the server 400 or another server from the aggregate A. A storage region reserved in this way is referred to as a logical volume. As one example, the management OS 140 creates a logical volume V1 using a storage region reserved from the RAID group R1 and creates a logical volume V2 using a storage region reserved from the RAID group R2. The management OS 140 also creates a logical volume V3 using a storage region reserved from the RAID groups R1 and R2. Here, the logical volumes V1, V2, and V3 are all logical volumes used to store backup data. In this configuration, the RAID groups R1 and R2 are used to store the backup data and are not used to store data that is read and written during everyday jobs.

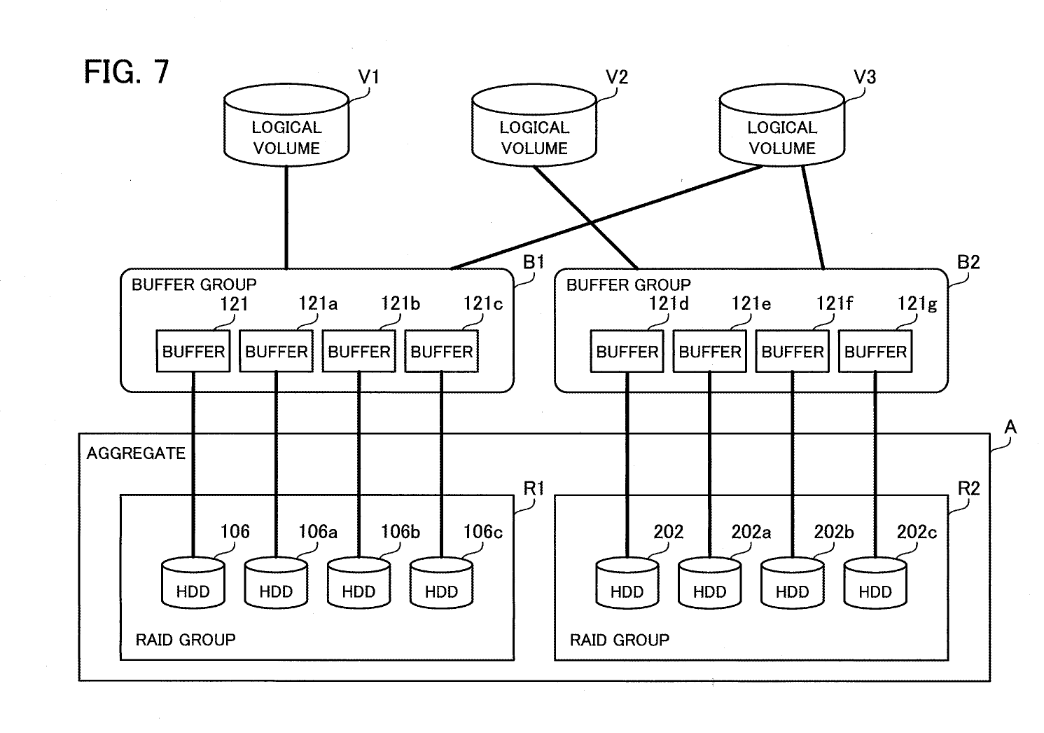

FIG. 7 depicts an example of correspondence between the logical volumes and buffers. The buffer control unit 150 provides a buffer for each HDD. For example, the RAID group R1 includes the HDDs 106, 106a, 106b, and 106c. In the example in FIG. 7, the buffer control unit 150 provides buffers 121, 121a, 121b, and 121c (the buffer group B1) that respectively correspond to the HDDs 106, 106a, 106b, and 106c.

The RAID group R2 includes the HDDs 202, 202a, 202b, and 202c. In the same way, the buffer control unit 150 includes buffers 121d, 121e, 121f, and 121g (the buffer group B2) that respectively correspond to the HDDs 202, 202a, 202b, and 202c. Here, the logical volume V1 is associated with the buffer group B1. The logical volume V2 is associated with the buffer group B2. The logical volume V3 is associated with the buffer groups B1 and B2.

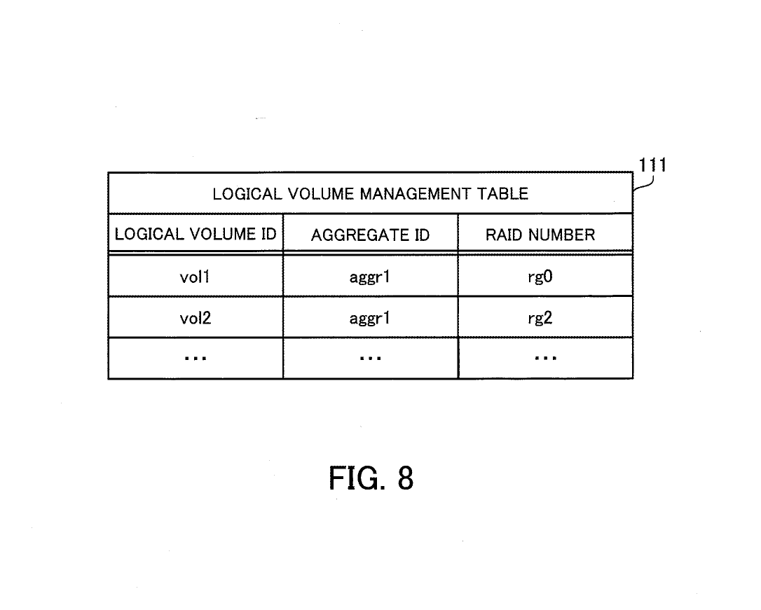

FIG. 8 depicts an example of a logical volume management table. The logical volume management table 111 is information for managing aggregates and/or RAID groups corresponding to logical volumes. The logical volume management table 111 is stored in the control information storage unit 110. The logical volume management table 111 includes logical volume ID (IDentifier), aggregate ID, and RAID number columns.

Identifiers of logical volumes are registered in the logical volume ID column. Identifiers of aggregates are registered in the aggregate ID column. Identifiers of RAID groups (referred to as “RAID numbers”) are registered in the RAID number column.

Here, the logical volume ID “vol1” depicted in FIG. 8 is the identifier of the logical volume V1. The logical volume ID “vol2” is the identifier of the logical volume V2. The aggregate ID “aggr1” is the identifier of the aggregate A. The RAID number “rg0” is the identifier of the RAID group R1. The RAID number “rg2” is the identifier of the RAID group R2.

As one example, information where the logical volume ID is “vol1”, the aggregate ID is “aggr1”, and the RAID is “rg0” is registered in the logical volume management table 111. This indicates that a storage region in the RAID group R1 that belongs to the aggregate A is assigned to the logical volume V1. Similar information is registered for other logical volumes in the logical volume management table 111.

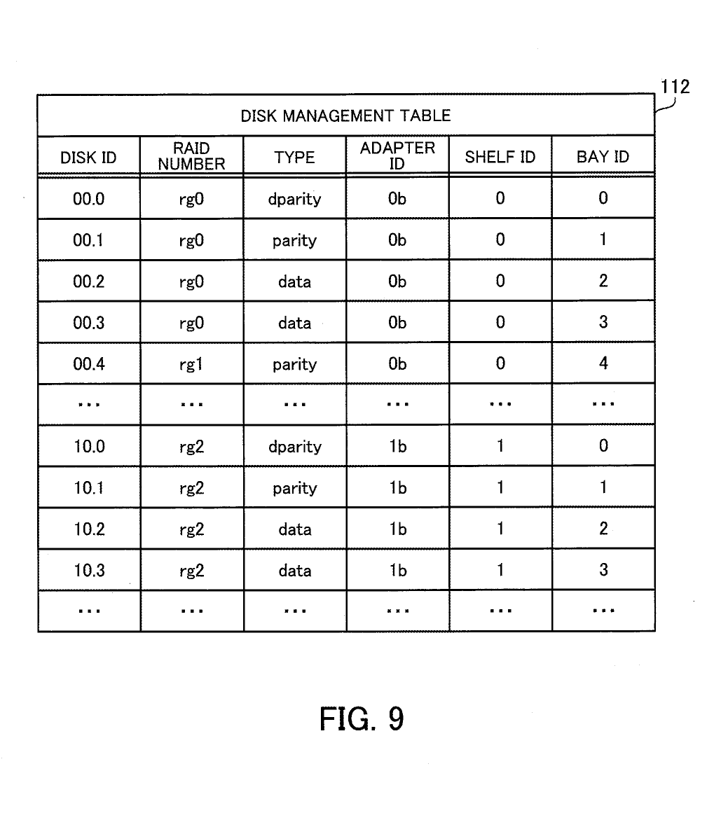

FIG. 9 depicts an example of the disk management table. The disk management table 112 is information for managing the HDDs in the storage apparatus 100 and the disk shelf 200. The disk management table 112 is stored in the control information storage unit 110. The disk management table 112 includes disk ID, RAID number, adapter ID, shelf ID, and bay ID columns.

The identifier of an HDD is registered in the disk ID column. A RAID number is registered in the RAID number column. The type of an HDD in the RAID is registered in the type column. Note that there is no setting in the RAID number and type columns for HDDs that do not belong to a RAID group. The identifier of an adapter used to access an HDD is registered in the adapter ID column. The identifier of the shelf housing an HDD is registered in the shelf ID column. The identifier of a bay in a shelf that houses an HDD is registered in the bay ID column. A bay is a storage space for mounting an HDD in the storage apparatus 100 or the disk shelf 200.

Here, in the disk management table 112, a case where RAID-DP (Double Parity) (“RAID DP” is a registered trademark in the US) are formed (the RAID groups with the RAID numbers “rg0” and “rg2”) is depicted as one example of RAID. RAID-DP is a disk configuration where an extra HDD for parity purposes (referred to as “double parity”) is added to a RAID4 group, which includes a plurality of HDDs for striping and a single HDD for parity purposes. Here, the types of HDDs in RAID-DP are registered in the type column described above. More specifically, when an HDD is used for striping, the type is “data”, while when an HDD is used for parity, the type is “parity”. For a double parity HDD, the type is “dparity”. However, it is also possible to use other types of RAID (as examples, RAID0, RAID1, or RAID5).

The disk ID “00.0” depicted in FIG. 9 is the identifier of the HDD 106. The disk ID “00.1” is the identifier of the HDD 106a. The disk ID “00.2” is the identifier of the HDD 106b. The disk ID “00.3” is the identifier of the HDD 106c. The disk ID “00.4” is the identifier of the HDD 106d. The disk ID “10.0” is the identifier of the HDD 202. The disk ID “10.1” is the identifier of the HDD 202a. The disk ID “10.2” is the identifier of the HDD 202b. The disk ID “10.3” is the identifier of the HDD 202c.

As one example, the disk ID “00.0”, the RAID number “rg0”, the type “dparity”, the adapter ID “0b”, the shelf ID “0”, and the bay ID “0” are registered in the disk management table 112. This information indicates that the HDD 106 identified by the disk ID “00.0” belongs to the RAID group R1 identified by the RAID number “rg0” and is used for double parity storage. The information also indicates that the HDD 106 is housed in the shelf (an internal shelf of the storage apparatus 100) identified by the shelf ID “0”, and is accessed via the adapter identified by the adapter ID “0b” out of the plurality of adapters provided in the disk control unit 105. In addition, the information indicates that the HDD 106 is housed in a bay indicated by the bay ID “0” out of the internal shelf of the storage apparatus 100.

The same information is registered for the other RAID and the HDDs. Here, the first two digits of the disk ID indicate whether an HDD is internally housed in the storage apparatus 100 or is housed in the external disk shelf 200. That is, when the first two digits of the disk ID are “00”, the HDD is internally housed in the storage apparatus 100. When the first two digits of the disk ID are “10”, the HDD is housed in the disk shelf 200. The shelf ID “1” is the shelf ID of the disk shelf 200.

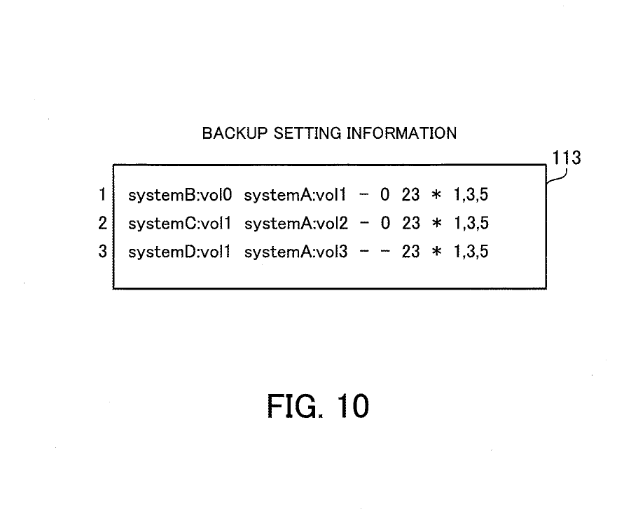

FIG. 10 depicts an example of backup setting information. The backup setting information 113 is information indicating the content and schedule of a backup process. The backup setting information 113 is stored in the control information storage unit 110. The numbers appended on the left in the backup setting information 113 are line numbers.

The backup settings are written in the backup setting information 113 in the format “backup data acquisition source apparatus name: volume name: backup data destination apparatus name: volume name−set times*set days”. Here, the backup data source apparatus name and the backup data destination apparatus name are written using the identifiers of the storage apparatuses. The identifier of the storage apparatus 100 is “systemA”, the identifier of the storage apparatus 100a is “systemB”, the identifier of the storage apparatus 100b is “systemC”, and the identifier of the storage apparatus 100c is “systemD”.

As one example, the information “systemB:vol0 systemA:vol1−0 23*1,3,5” is set on the first line of the backup setting information 113. This indicates that a backup of the data stored in the logical volume “vol0” of the storage apparatus 100a is to be acquired in the logical volume “vol1” of the storage apparatus 100. The schedule setting is the “0 23*1,3,5” part, and indicates that a backup is to be acquired at 0 minutes past every hour, every day at 11:00 pm, and at 0:00 on Monday morning every week (these settings correspond to the setting “1”), at 0:00 on Wednesday morning every week (this corresponds to the setting “3”), and at 0:00 on Friday morning every week (this corresponds to the setting “5”).

The records on the second and third lines are the same. However, the schedule setting is “−23*1,3,5” in the record on the third line. This indicates that a backup is to be acquired every day at 11:00 pm, at 0:00 on Monday morning every week, at 0:00 on Wednesday morning every week, and at 0:00 on Friday morning every week.

Note that the logical volumes “vol1”, “vol2”, and “vol3” are each generated using backup HDDs. The backup setting information 113 is generated in advance by the system manager or the like and is stored in the control information storage unit 110. Also, although example settings are depicted for a case where backups are acquired in units of logical volumes in the example described above, it is also possible to designate the source and destination for acquisition of a backup in other units, such as units of directories on a level below a logical volume.

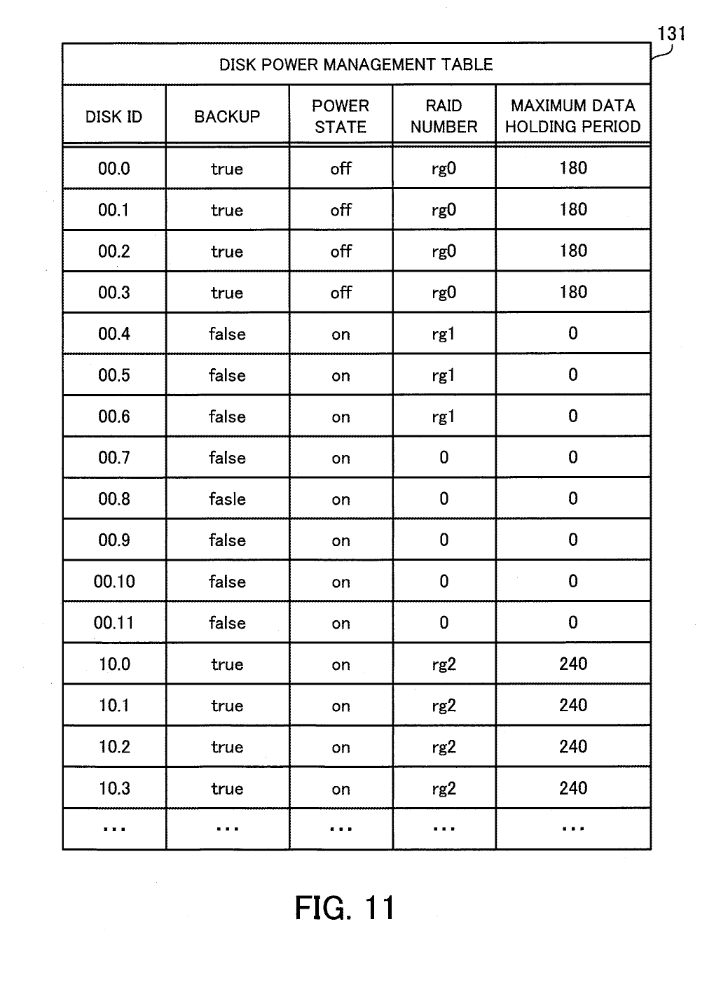

FIG. 11 depicts an example of a disk power management table. The disk power management table 131 is stored in the power information storage unit 130. The disk power management table 131 includes disk ID, backup, power state, RAID number, and maximum data holding period columns.

The identifier of an HDD is registered in the disk ID column. Information (“true” or “false”) indicating whether the HDD is a backup HDD is registered in the backup column, with “true” indicating a backup HDD and “false” indicating that the HDD is not a backup HDD. Information (“on” or “off”) indicating whether the power is on is registered in the power state column, with “on” indicating that the power is on and “off” indicating that the power is off. A RAID number is registered in the RAID number column. When an HDD does not belong to a RAID group, the RAID number is set at “0”. The maximum data holding period is registered in the maximum data holding period column. As one example, the maximum data holding period is expressed in minute units (other units such as seconds may be used). Since the maximum data holding period is set for the buffer of a backup HDD, “0” is set for an HDD that is not a backup HDD.

As one example, information where the disk ID is “00.0”, the backup is “true”, the power state is “off”, the RAID number is “rg0”, and the maximum data holding period is “180 (minutes)” is registered in the disk power management table 131. Here, the HDD identified by the disk ID “00.0” is a backup HDD whose power state is presently off. Such HDD belongs to the RAID group identified by the RAID number “rg0” and the maximum data holding period is indicated as 180 minutes. Note that the set value of the maximum data holding period is the same value for each HDD belonging to the same RAID group. This is because the HDDs belonging to the same RAID group are accessed at the same time.

Information where the disk ID is “00.4”, the backup is “false”, the power state is “on”, the RAID number is “rg1”, and the maximum data holding period is “0 (minutes)” is also registered in the disk power management table 131. Here, the HDD identified by the disk ID “00.4” is not a backup HDD and the power state is presently on. Such HDD belongs to the RAID group identified by the RAID number “rg1” and the maximum data holding period is indicated as 0 minutes (since the HDD with the disk ID “00.4” is not a backup HDD). The same information is registered for other HDDs in the disk power management table 131.

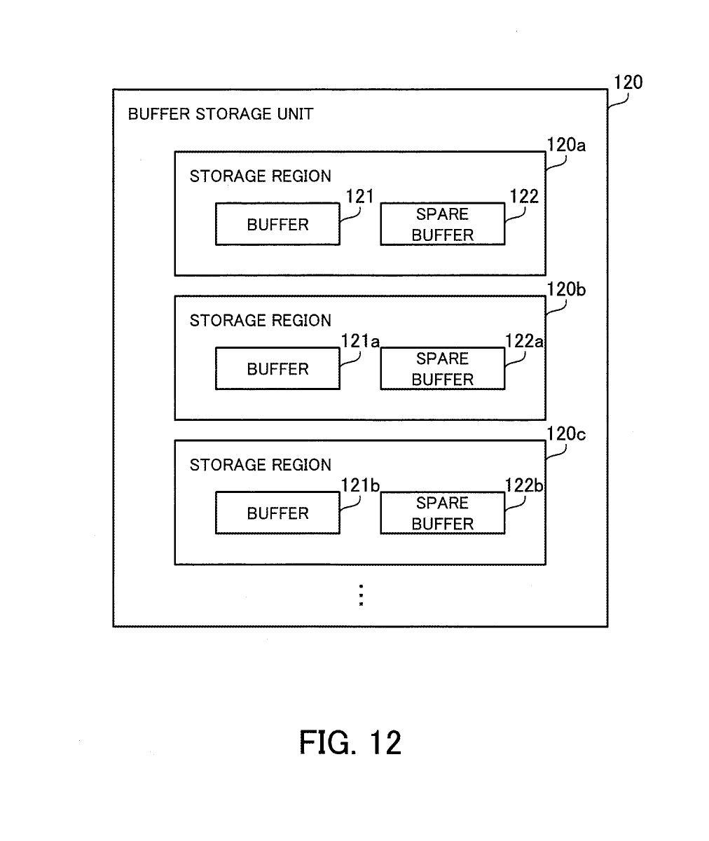

FIG. 12 depicts examples of buffers. The buffer storage unit 120 includes storage regions 120a, 120b, 120c . . . that respectively correspond to the backup HDDs. As one example, the storage region 120a corresponds to the HDD 106. More specifically, the buffer control unit 150 reserves a range of memory addresses corresponding to the storage region 120a for the HDD 106. In the same way, the storage region 120b corresponds to the HDD 106a and the storage region 120c corresponds to the HDD 106b. The buffer control unit 150 may store information indicating which ranges of addresses correspond to which HDD in advance in a predetermined storage region of the memory 102.

As described earlier, the buffer control unit 150 uses a two-sided configuration for the buffer for each backup HDD. More specifically, the buffer control unit 150 provides a buffer 121 and a spare buffer 122 by dividing the storage region 120a into two. The buffer 121 is a storage region for storing backup data that is to be written in the HDD 106 but is received when the power of the HDD 106 is off. The spare buffer 122 is a storage region for storing additional backup data received while the power of the HDD 106 is on and backup data is being written into the HDD 106.

In the same way, the buffer control unit 150 provides a buffer 121a and a spare buffer 122a by dividing the storage region 120b into two and provides a buffer 121b and a spare buffer 122b by dividing the storage region 120c into two.

As one example, the buffer control unit 150 decides the total size of the storage regions 120a, 120b, 120c . . . in accordance with the ratio of the assigned number of backup HDDs to the total number of HDDs. As a specific example, consider a case where the usable storage capacity of the memory 102 is 32 gigabytes and fifteen out of thirty HDDs are set as backup HDDs. Here, the ratio of the backup HDDs is 15/30=0.5, or 50%. Accordingly, the buffer control unit 150 sets the total size of the storage regions 120a, 120b, 120c . . . at 32 GB×0.5=16 GB. As one example, the buffer control unit 150 assigns the decided total size of 16 GB equally to the storage regions 120a, 120b, 120c . . . . When the total number of storage regions 120a, 120b, 120c . . . (that is, the total number of backup HDDs) is sixteen, the storage capacity of each of the storage regions 120a, 120b, 120c . . . is 16 GB=16=1 GB. The buffer control unit 150 sets half of the storage capacity assigned to the storage region 120a (for example, 0.5 GB) as the buffer 121 and the remaining half (for example, 0.5 GB) as the spare buffer 122.

Note that although a storage region with a predetermined range of addresses is provided as a buffer for each backup HDD in the example depicted in FIG. 12, other methods may be used. As one example, it would be conceivable to store backup data in the buffer storage unit 120 after appending with identification information of the backup HDD that is the write destination. By doing so, it is possible for the buffer control unit 150 to specify the write destination HDD of the backup data based on the identification information of the HDD appended to the backup data. With this configuration, it is possible to store backup data with any backup HDD as a write destination at any memory address in the memory 102. It is also possible for example to regard a group of regions in which backup data appended with the identification information of the HDD 106 is stored as the buffer 121 corresponding to the HDD 106. It is also possible in this case to decide the size of each buffer in advance.

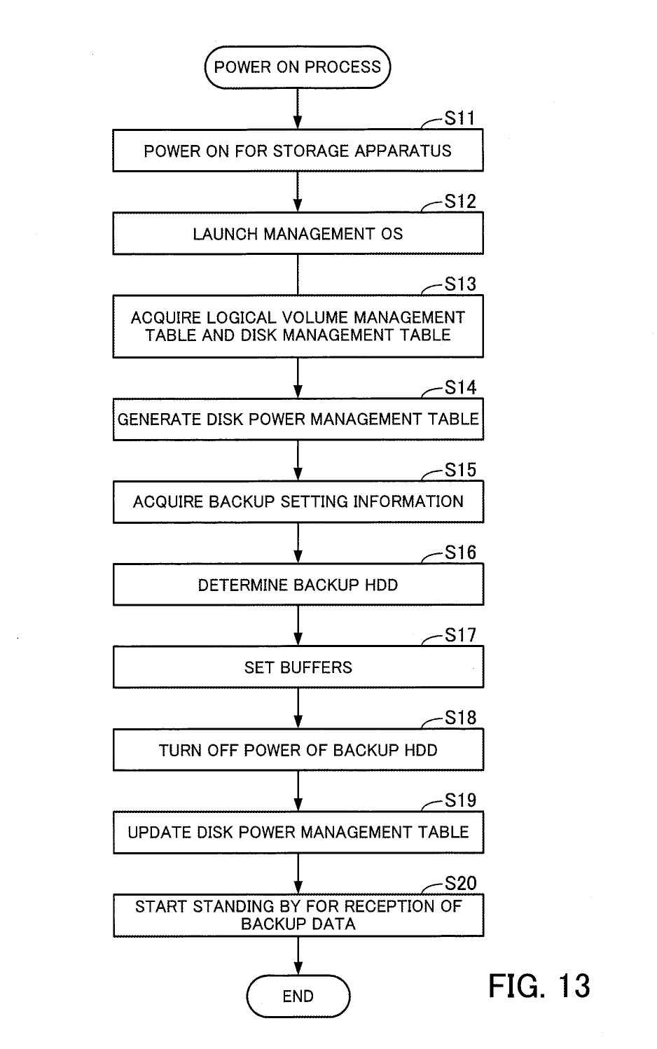

FIG. 13 is a flowchart depicting an example of a power-on process. The processing depicted in FIG. 13 is described below in order of the step numbers.

(S11) The power of the storage apparatus 100 is turned on. The power of the disk shelf 200 is also turned on. As one example, the manager can perform a power on operation for the storage apparatus 100 and the disk shelf 200 by pressing power buttons of the storage apparatus 100 and the disk shelf 200. The storage apparatus 100 and the disk shelf 200 perform a power-on process. At this time, the power is turned on for all of the HDDs housed in the storage apparatus 100 and the disk shelf 200.

(S12) By executing a program of the management OS 140 stored in the ROM 104, the processor 101 realizes the functions of the management OS 140. By executing programs of the buffer control unit 150 and the disk power control unit 160 stored in the ROM 104, the processor 101 realizes the functions of the buffer control unit 150 and the disk power control unit 160.

(S13) The management OS 140 acquires the logical volume management table 111 and the disk management table 112 from the control region of the HDD 106. The management OS 140 also recognizes the existence of each HDD registered in the disk management table 112 via the disk control units 105 and 201.

(S14) The disk power control unit 160 generates the disk power management table 131 based on the disk management table 112 and stores the disk power management table 131 in the power information storage unit 130. More specifically, the disk power control unit 160 acquires the disk ID and RAID number of each HDD from the disk management table 112 and registers the ID and number in the disk power management table 131. At the timing of step S14, no setting needs to be made in the backup column. The power state column is “on” for every HDD. A set value that is designated in advance for each RAID number or for each disk ID (as one example, such designated set values are also stored in advance in the control region of the HDD 106) is registered in the maximum data holding period column. As described earlier, the maximum data holding period of each HDD belonging to the same RAID group is the same set value.

(S15) The management OS 140 acquires the backup setting information 113 from the control region of any of the HDDs (such as the HDD 106) housed in the storage apparatus 100.

(S16) The disk power control unit 160 determines which HDDs are backup HDDs based on the logical volume management table 111, the disk management table 112, and the backup setting information 113. More specifically, the disk power control unit 160 refers to the backup setting information 113 and acquires the logical volume identifier (for example, “vol1”) of the storage destination of the backup data out of the logical volumes managed by the storage apparatus 100. The disk power control unit 160 acquires the RAID group that provides the storage region of the logical volume in question from the logical volume management table 111. As one example, according to the logical volume management table 111, the RAID group of the RAID that provides the storage region of the logical volume corresponding to the identifier “vol1” is “rg0”. In addition, the disk power control unit 160 refers to the disk management table 112 and acquires HDDs that belong to the RAID group of the acquired RAID number. As one example, according to the disk management table 112, the HDDs that belong to the RAID group with the RAID group number “rg0” are the HDDs 106, 106a, 106b, and 106c with the disk ID “00.0”, “00.1”, “00.2”, and “00.3”. The disk power control unit 160 sets the backup column of the disk power management table 131 at “true” for the HDDs determined to be backup HDDs. The same column is set at “false” for the other HDDs.

(S17) The buffer control unit 150 refers to the disk power management table 131 and sets a buffer for each HDD for which the backup column is set at “true”. At this time, the buffer control unit 150 sets a buffer with a two-sided configuration for each HDD as described earlier. The method of deciding the sizes of the buffers is as described earlier.

(S18) The disk power control unit 160 carries out control to turn off the power of the backup HDDs. More specifically, the disk power control unit 160 turns off the power of the backup HDDs including the HDDs 106, 106a, 106b, and 106c via the disk control unit 105. The disk power control unit 160 also turns off the power of the backup HDDs including the HDDs 202, 202a, 202b, and 202c via the disk control units 105 and 201.

(S19) The disk power control unit 160 sets the power state column of the disk power management table 131 at “off” for HDDs whose power is off.

(S20) The management OS 140 starts to stand by for reception of backup data.

In this way, when the power is turned on for the storage apparatus 100, the storage apparatus 100 generates the disk power management table 131 and when every HDD has been recognized, the power of the backup HDDs is turned off. Here, HDDs are sometimes replaced due to failures that occur during operation. This means that the combination of HDDs that form a RAID may change due to HDDs being replaced. For this reason, the storage apparatus 100 updates the disk power management table 131 in accordance with failures and replacement of HDDs.

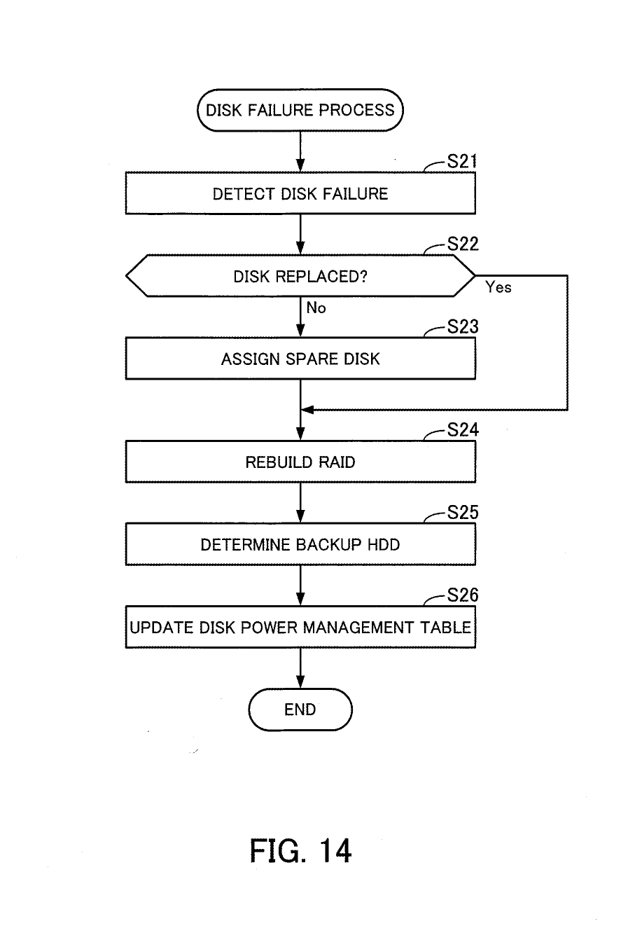

FIG. 14 is a flowchart depicting an example of a disk failure process. The processing depicted in FIG. 14 is described below in order of the step numbers.

(S21) The management OS 140 detects a failure of one of the HDDs housed in the storage apparatus 100 or the disk shelf 200. As one example, the management OS 140 may detect the failure of a backup HDD while backup data is being written into the backup HDD. Alternatively, it would be conceivable for the management OS 140 to regularly turn on the backup HDDs, whose power is normally off, to check for failures.

(S22) The management OS 140 determines whether any HDDs have been replaced. When an HDD has been replaced, the processing proceeds to step S24. When no HDDs have been replaced, the processing proceeds to step S23.

(S23) The management OS 140 assigns a spare disk provided in the storage apparatus 100 or in the disk shelf 200 (a spare HDD provided in advance in preparation for an HDD failure) in place of the failed HDD.

(S24) The management OS 140 uses the HDD after replacement (when the “Yes” branch is taken in step S22) or the spare disk (when the “No” branch is taken in step S22) to rebuild the RAID to which the failed HDD belonged. As one example, when the type of the failed HDD is “data”, the management OS 140 restores the data of the replacement HDD from the parity and/or other data stored in the other HDDs belonging to the RAID. Alternatively, when the type of the failed HDD is “parity” or “dparity”, the management OS 140 restores the parity data of the replacement HDD from the parity and/or other data stored in the other HDDs belonging to the RAID. The management OS 140 operates the disk management table 112 to update the correspondence between the HDDs and the RAID. As one example, when the spare disk is substituted, the adapter ID, the shelf ID, and the bay ID are updated to information corresponding to the location of the spare disk.

(S25) The disk power control unit 160 refers to the disk power management table 131 and determines whether the HDDs belonging to the rebuilt RAID group are backup HDDs.

(S26) The disk power control unit 160 updates the disk power management table 131. As one example, information on the failed HDD is deleted and information on the HDD newly assigned to the rebuilt RAID group is added. When the rebuild RAID group is used for backup purposes, the newly assigned HDD is also set as a backup HDD (“true” is set in the backup column).

As one example, when a failure was detected in step S21 for the write destination HDD while the backup data stored in a buffer is being written into a backup HDD, the buffer control unit 150 continues the write of the backup data after step S26. The disk power control unit 160 turns off the power of the write destination HDD after the write is completed. Alternatively, when failure of a backup HDD is detected by checking whether there has been a backup failure in step S21, the disk power control unit 160 turns off the HDD after replacement (and the other HDDs that form the RAID with the HDD in question) after step S26.

In this way, even when any of the HDDs has failed, the storage apparatus 100 updates the disk power management table 131 in accordance with the replacement of the HDD and/or the assignment of the spare disk. By doing so, even when the assignment of HDDs to RAID groups has changed, it is possible to appropriately reflect the result of such change in the disk power management table 131.

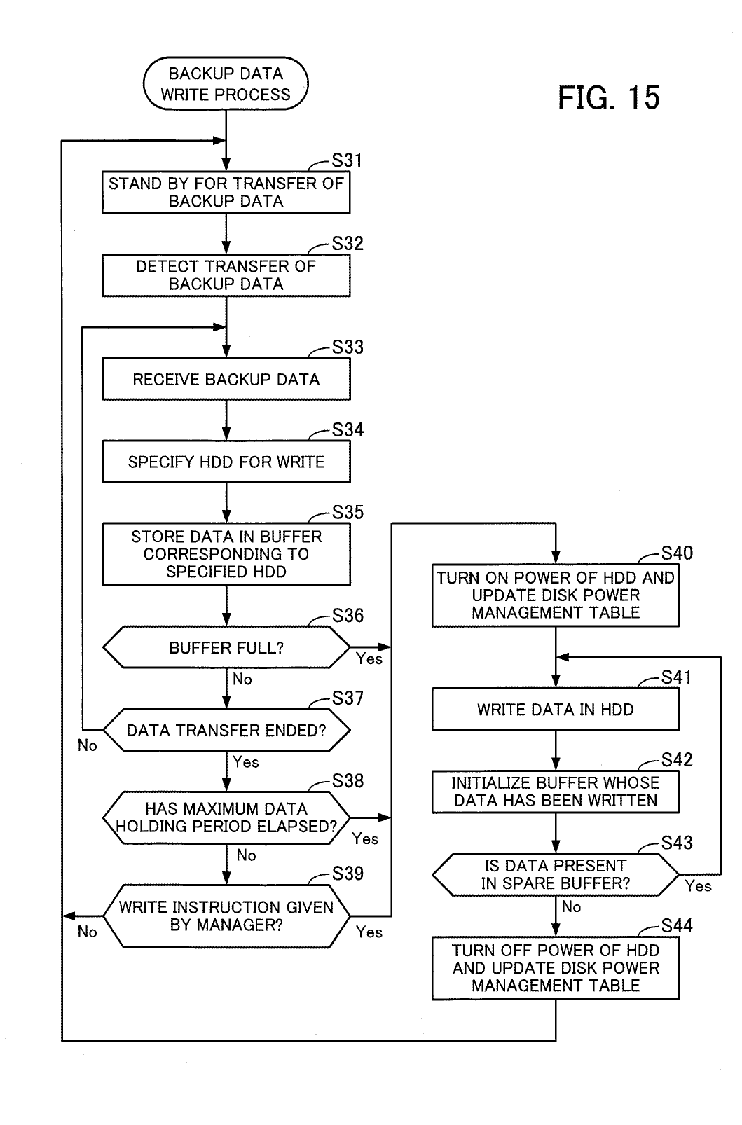

FIG. 15 is a flowchart depicting an example of a backup data writing process. The processing depicted in FIG. 15 is described below in order of the step numbers.

(S31) The management OS 140 stands by for transfer of backup data from any of the storage apparatuses.

(S32) The management OS 140 detects that backup data has been transferred from any of the storage apparatuses. As one example, data to be written and the logical volume ID of the write destination are included in a write request for data. When the write destination is a logical volume for storing backup data, the management OS 140 recognizes that the data to be written is backup data. For the example of the backup setting information 113, when the logical volume ID of the write destination is “vol1”, “vol2”, or “vol3”, the data to be written is backup data.

(S33) The management OS 140 receives the backup data from the storage apparatus that is the transfer source.

(S34) The buffer control unit 150 specifies, based on the logical volume management table 111 and the disk management table 112, HDDs that correspond to the logical volume that is the write destination of the received backup data. As one example, when the logical volume ID of the write destination is “vol1”, the disk IDs of the corresponding HDDs are “00.0”, “00.1”, “00.2”, and “00.3”.

(S35) The buffer control unit 150 stores the received backup data in the buffer corresponding to the specified HDD. When a plurality of HDDs are specified (a RAID), the backup data is stored so as to be distributed between a plurality of buffers corresponding to a plurality of HDDs (for parity disks, the calculation result of parity is stored). At the timing at which the received backup data is first stored in the buffer(s) in question, the buffer control unit 150 also starts measuring time using the timer(s) corresponding to such buffer(s).

(S36) The buffer control unit 150 determines whether the buffer region of a buffer in which backup data was stored in step S35 is full (the “buffer full” state). When a buffer is full, the processing proceeds to step S40. When a buffer is not full, the processing proceeds to step S37. As one example, as described earlier, the buffer control unit 150 may determine that a buffer is full when the total size of the backup data stored in the buffer in question is equal to or greater than a threshold.

(S37) The management OS 140 determines whether the transferring of backup data has ended. When the transferring has ended, the processing proceeds to step S38. When the transferring has not ended, the processing proceeds to step S33. As one example, by receiving notification from the storage apparatus that is the transfer source of the backup data that transferring of all of the backup data has ended, the management OS 140 detects that the transferring of the backup data has ended.

(S38) The buffer control unit 150 determines whether the time measured by a timer that started measurement in step S35 has reached the maximum data holding period registered in the disk power management table 131. When the maximum data holding period has been reached, the time measured by the timer in question is reset to zero and the processing proceeds to step S40. When the maximum data holding period has not been reached, the processing proceeds to step S39.

(S39) The buffer control unit 150 determines whether a write instruction for backup data has been given by the manager. When a write instruction has been given, the processing proceeds to step S40. When a write instruction has not been given, the processing proceeds to step S31. Here, by operating the management apparatus 300, the manager is capable of inputting to the storage apparatus 100 an instruction (“write instruction”) that writes backup data, which is stored in a buffer, into a logical volume.

(S40) The disk power control unit 160 turns on the power of the write destination HDD of the backup data. When the write destination HDD forms a RAID, the disk power control unit 160 turns on the power of all the HDDs that belong to the RAID group in question. The disk power control unit 160 updates the disk power management table 131. More specifically, the disk power control unit 160 changes the setting of the power states of the HDDs whose power has been turned on from “off” to “on” in the disk power supply management table 131.

(S41) The buffer control unit 150 reads the backup data from the buffers corresponding to the HDDs whose power was turned on in step S40. The buffer control unit 150 instructs the management OS 140 to write the read backup data into the HDD corresponding to the buffer. The management OS 140 writes the backup data into the designated HDD. When the power was turned on for a plurality of HDDs in step S40, backup data is read from a plurality of buffers and the backup data is written into a plurality of HDDs. While a write is being performed, the management OS 140 may receive additional backup data from a storage apparatus that has issued a write request. In this situation, the buffer control unit 150 stores the received additional backup data in a spare buffer corresponding to the write destination HDD.

(S42) The buffer control unit 150 initializes the buffer(s) whose backup data has been written into HDDs. More specifically, the buffer control unit 150 enables the buffer region(s) of the buffer(s) in question to be reused (i.e., enables overwriting).

(S43) The buffer control unit 150 determines whether additional backup data has been stored in the spare buffer. When additional backup data has been stored, the processing proceeds to step S41. When additional backup data has not been stored, the processing proceeds to step S44. When the processing proceeds to step S41 after the determination in step S43, the buffer control unit 150 executes the processing in steps S41 and S42 for the spare buffer. That is, the buffer control unit 150 instructs the management OS 140 to write the additional backup data stored in the spare buffer into an HDD. In response, the management OS 140 writes the additional backup data into the designated HDD.

(S44) The disk power control unit 160 turns off the power of the HDD into which the backup data was written. When the write destination HDD forms a RAID, the disk power control unit 160 turns off the power of a plurality of HDDs. The disk power control unit 160 updates the disk power management table 131. More specifically, the disk power control unit 160 changes the setting of the power state of the HDD into which the backup data was written from “on” to “off” in the disk power management table 131. The processing then proceeds to step S31.

Note that in steps S38 and S39, when the time measured by the timer after the end of data transfer has not reached the maximum data holding period and a write instruction has not been given by the manager, the processing proceeds to step S31. After this, the buffer control unit 150 continues to monitor the timer and to monitor for the input by the manager of a write instruction for the backup data.

As one example, when the time measured by any of the timers has reached the maximum data holding period, the buffer control unit 150 resets the measured time of such timer and executes the processing in steps S40 to S44 for the buffer in question. By providing a maximum data holding period for a buffer, it is possible to prevent backup data from remaining unwritten into an HDD, which would lower the reliability of having data held in buffers.

Also, on receiving the input of a write instruction for backup data into a logical volume, the buffer control unit 150 reads backup data from the buffer corresponding to the HDD belonging to the logical volume that is the write destination and executes the processing in steps S40 to S44. By writing backup data into an HDD in accordance with a write instruction given by the manager, it is possible to prevent backup data from remaining unwritten into an HDD, which would lower the reliability of having data held in buffers.

By storing additional backup data received while backup data is being written in an HDD in the spare buffer, interruptions to the backup process are avoided. For example, it is possible to reduce the frequency with which notifications of write failure errors for buffers and requests for resending of the additional backup data are transmitted to the transfer source of the backup data. It is also possible to perform writes of backup data from a buffer into an HDD and storage of additional backup data into a spare buffer in parallel, which makes the backup process more efficient.

In addition, although backup data is stored in the buffer that corresponds to the specified HDD in step S35, as described earlier, it is also possible to append the identifier of the specified HDD to the backup data and store the backup data in the buffer storage unit 120. With this configuration, in step S36, the buffer control unit 150 calculates the total size of the backup data that has been appended with the identifier of the same HDD. The buffer control unit 150 can determine whether the buffer corresponding to an HDD is full according to whether the calculated total has reached a buffer size that is decided in advance.

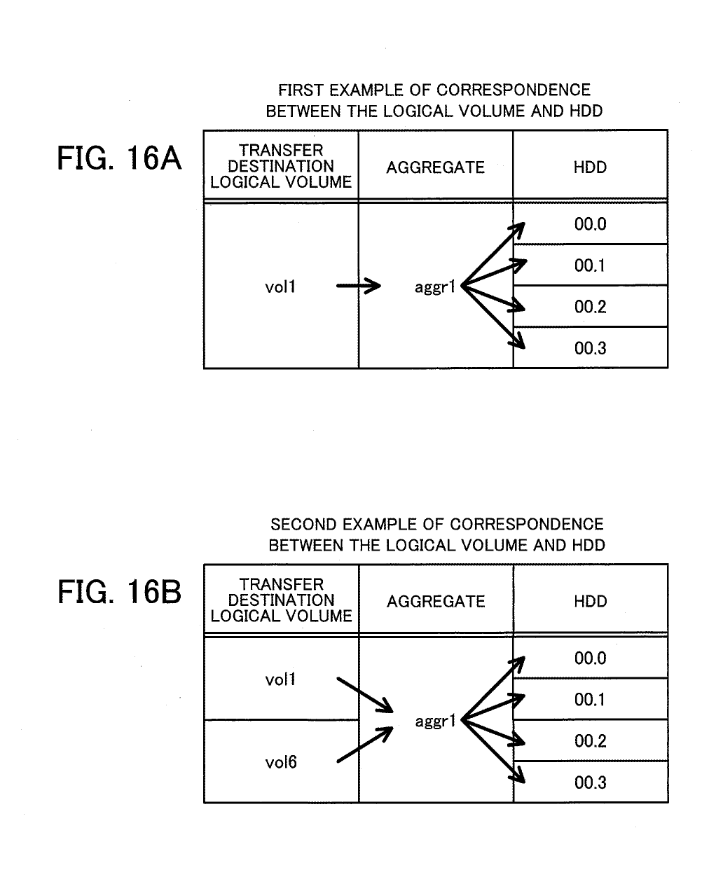

FIGS. 16A and 16B depict examples of correspondence between logical volumes and HDDs. FIG. 16A illustrates buffers and HDDs in which backup data that has the logical volume with the logical volume ID “vol1” as the transfer destination is stored. As described earlier, based on the logical volume management table 111 and the disk management table 112, the buffer control unit 150 specifies the HDD in accordance with the logical volume that is the transfer destination of the backup data, and specifies the buffer corresponding to the HDD.

As one example, the buffer control unit 150 receives a write request of backup data for which the transfer destination volume V1 (ID “vol1”) is designated. The buffer control unit 150 then specifies the RAID group R1 (with the RAID number “rg0”) of the aggregate A (aggregate ID “aggr1”) corresponding to the transfer destination volume V1. The buffer control unit 150 then specifies the HDDs 106, 106a, 106b, and 106c (with the disk IDs “00.0”, “00.1”, “00.2”, and “00.3”) that belong to the RAID group R1. The buffer control unit 150 also specifies the buffers 121, 121a, 121b, and 121c that respectively correspond to the HDDs 106, 106a, 106b, and 106c.

The buffer control unit 150 stores the backup data (which includes parity) so as to be distributed between the buffers 121, 121a, 121b, and 121c. As one example, the buffer control unit 150 stores three data pieces, which are produced by dividing the backup data, and one parity data so as to be distributed between the buffers 121, 121a, 121b, and 121c. At timing such as when a buffer is full, the buffer control unit 150 writes the backup data stored in the buffers 121, 121a, 121b, and 121c into the HDDs 106, 106a, 106b, and 106c corresponding to the respective buffers. When a write is not being performed, the power of the HDDs 106, 106a, 106b, and 106c can be turned off.

FIG. 16B depicts a situation where backup data that has two logical volumes (with the logical volume ID “vol1” and “vol6”) corresponding to one aggregate A (with the aggregate ID “aggr1”) as a transfer destination is received. Here, the buffer control unit 150 buffers the backup data that has the logical volume ID (“vol1”) as a transfer destination using the buffers 121, 121a, 121b, and 121c. The buffer control unit 150 also buffers the backup data that has the logical volume ID (“vol6”) as a transfer destination using the buffers 121, 121a, 121b, and 121c. At timing such as when a buffer is full, the buffer control unit 150 writes the backup data stored in the buffers 121, 121a, 121b, and 121c into the HDDs 106, 106a, 106b, and 106c corresponding to the respective buffers. When a write is not being performed, the power of the HDDs 106, 106a, 106b, and 106c can be turned off.

The processing described above may be expressed as follows. The buffer control unit 150 stores a plurality of data pieces and parity data of one set of backup data in the buffers for the backup HDDs. The buffer control unit 150 buffers a plurality of sets of backup data so that data pieces or the parity data are aggregated on a backup HDD basis. When the power of a backup HDD has been turned on, the buffer control unit 150 collectively writes data pieces or parity data that have been aggregated for such backup HDD.

In this way, the storage apparatus 100 normally keeps the power of the backup HDDs off. The storage apparatus 100 accumulates backup data in the buffers for each backup HDD. When a write of backup data is to be carried out, the storage apparatus 100 turns on the power of the write destination backup HDD and when the write is completed, the power of the HDD is turned off again. By doing so, it is possible to reduce the power consumption of the storage apparatus 100 and the disk shelf 200.

In many cases, the backup process is carried out during time zones where user jobs are not affected. As one example, performing the backup process during a time zone where user jobs are not affected (for example, a time zone following the end of a job) and turning off the power of the storage apparatus 100 and/or the disk shelf 200 once the backup process has been completed would conceivably result in reduced power consumption. However, in recent years, it is common for the storage apparatus 100 and the disk shelf 200 to be shared by a plurality of users who are located in different regions and perform different jobs, and therefore users often perform jobs in different time zones. This means that there is a high probability of the storage apparatus 100 and/or the disk shelf 200 being used for some type of processing (job processing, backup processing, or the like) at all times, which makes it difficult to turn off the power in units of the storage apparatus 100 and the disk shelf 200 at a set time.

For this reason, the storage apparatus 100 normally keeps the power of the plurality of HDDs for storing backup data off and holds the backup data received while the power of the HDDs is off in buffers provided for each HDD. The storage apparatus 100 turns the power of individual HDDs on only while data is being written from a buffer and turns the power back off when the write has been completed. By doing so, power consumption is reduced compared to a configuration where all of the backup HDDs are turned on at once. In particular, the power consumption of the storage apparatus 100 and/or the disk shelf 200 is reduced even when it is difficult to turn off the power in units of the storage apparatus 100 and/or the disk shelf 200.

### Third Embodiment

A third embodiment will now be described. The description will focus on the differences with the second embodiment described above and description of common features and configurations is omitted. A controller that controls access to HDDs may be provided as a separate apparatus (or “storage control apparatus”) to the apparatuses housing the HDDs.

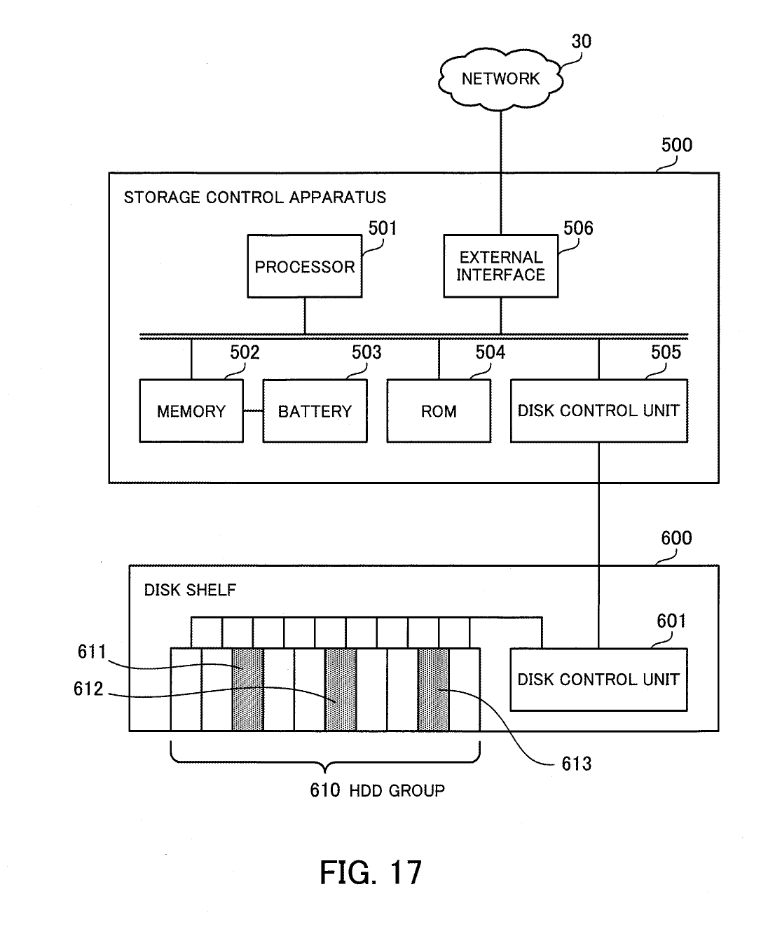

FIG. 17 depicts example hardware of a storage control apparatus according to the third embodiment. The storage control apparatus 500 includes a processor 501, a memory 502, a battery 503, a ROM 504, a disk control unit 505, and an external interface 506. The respective units are connected to a bus of the storage control apparatus 500.

The processor 501 controls information processing by the storage control apparatus 500. The processor 501 may be a multiprocessor. As examples, the processor 501 is a CPU, a DSP, an ASIC, or an FPGA. The processor 501 may also be a combination of two or more of a CPU, a DSP, an ASIC, and an FPGA.

The memory 502 is main storage of the storage apparatus 500. The memory 502 temporarily stores at least part of an OS (management OS of the storage apparatus 500) program and an application program to be executed by the processor 501. The memory 502 also stores various data used in processing by the processor 501. The memory 502 is a non-volatile storage apparatus that is backed up by the battery 503.

The battery 503 is a cell that supplies power to the memory 502.

The ROM 504 stores management OS programs, application programs, and various data. The ROM 504 may be a rewritable memory.

The disk control unit 505 is connected using a predetermined cable to a disk shelf 600. The disk shelf 600 houses a plurality of HDDs (or other storage resources such as SSDs). As one example, it is possible to use SAS as the interface of the disk control unit 505. In accordance with instructions from the processor 501, the disk control unit 505 supplies with the disk shelf 600 with instructions for writes of data into the HDDs housed in the disk shelf 600 and reads of data from the HDDs. In accordance with instructions from the processor 501, the disk control unit 505 also supplies the disk shelf 600 with on and off instructions for the power of individual HDDs housed in the disk shelf 600.

The external interface 506 is a communication interface for communication with other apparatuses via the network 30. Examples of the other apparatuses referred to here are the management apparatus 300 and the server 400 described in the second embodiment, and other storage apparatuses. Such other apparatuses have been omitted from FIG. 17.

The disk shelf 600 includes a disk control unit 601 and an HDD group 610. The disk control unit 601 is connected to the disk control unit 505 using a predetermined cable. The disk control unit 601 receives instructions by the processor 501 via the disk control unit 505 and performs writes of data onto the HDDs housed in the disk shelf 600 and reads of data from the HDDs in accordance with the instructions. In the same way as the disk control unit 505, SAS may be used as the interface of the disk control unit 601. The HDD group 610 includes HDDs 611, 612, and 613. The HDDs 611, 612, and 613 are backup HDDs.

By executing programs stored in the ROM 504, the processor 501 realizes the functions of the management OS 140, the buffer control unit 150, and the disk power control unit 160 depicted in FIG. 5. Using such functions, the processor 501 controls writes of backup data into HDDs housed in the disk shelf 600 in the same way as in the second embodiment.

More specifically, the processor 501 provides buffers respectively corresponding to the HDDs 611, 612, and 613 in the storage region of the memory 502. The processor 501 normally keeps the power of the HDDs 611, 612, and 613 off, and on receiving a write request for backup data into the HDDs 611, 612, and 613, writes the backup data into the buffers corresponding to the respective HDDs.

As one example, the processor 501 turns on the power of the HDD 611 via the disk control units 505 and 601 at predetermined timing. As examples, the predetermined timing may be any of timing at which a buffer becomes full, timing at which the time elapsed from the storage of backup data in a buffer has reached the maximum data holding time, and timing at which the inputting of a write instruction for writing backup data into an HDD has been received. The processor 501 then writes the backup data stored in the buffer corresponding to the HDD 611 via the disk control units 505 and 601 into the HDD 611. When the write has been completed, the processor 501 turns off the power of the HDD 611 via the disk control units 505 and 601.

The HDDs 611, 612, and 613 may form a RAID, and in such case, the processor 501 turns on the power to the HDDs 611, 612, and 613 at the same time (or with slightly different timing) and writes the backup data (or parity calculated from the backup data) so as to be distributed between the HDDs 611, 612, and 613. Once the write has been completed, the processor 501 turns off the power of the HDDs 611, 612, and 613. By doing so, the storage control apparatus 500 reduces the power consumption of the disk shelf 600 in the same way as in the second embodiment.

Note that the information processing in the first embodiment can be realized by the control unit 12 executing a program. In the same way, the information processing in the second and third embodiments can be realized by the processors 101 and 501 executing programs. Such programs can be recorded on the computer-readable storage medium 43.

As one example, it is possible to distribute the program by distributing the storage medium 43 on which the program has been recorded. The program may also be stored on another computer and distributed via a network. The storage apparatus 100 includes a computer provided with the processor 101 and the memory 102. The storage control apparatus 500 includes a computer provided with the processor 501 and the memory 502. As one example, the computer may store (install) the program recorded on the storage medium 43 or a program received from another computer (for example, the management apparatus 300 or another server) in the memories 102 and 502 or a storage resource such as a non-volatile storage resource. With such configuration, the computer reads out and executes the program from the storage resource where the program was installed.

According to one aspect, it is possible to reduce power consumption.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a memory that stores backup data that has a plurality of storage resources, which are used to store the backup data and whose power can be individually turned on and off, as write destinations; and
a processor that performs a control procedure including:
storing, whenever a write request for backup data for a storage resource out of the plurality of storage resources has been received while the power of the storage resource is off, the backup data in the memory so as to be associated with the storage resource;
separately turning on, at predetermined timing, the power of one or more storage resources that are the write destinations of the backup data stored in the memory, out of the plurality of storage resources;
reading the backup data associated with the one or more storage resources whose power has been turned on from the memory and writing the backup data into the one or more storage resources; and
turning off the power of the one or more storage resources for which the writing has been completed.

2. The storage control apparatus according to claim 1,
wherein after the power of the plurality of storage resources has been turned on during activation of the storage control apparatus, the processor turns off the power of the plurality of storage resources.

3. The storage control apparatus according to claim 1,
wherein when sets of backup data are to be stored so as to be distributed between the plurality of storage resources, the processor stores the backup data in the memory so as to be aggregated for each storage resource and writes, into the one or more storage resources whose power has been turned on, the backup data that has been aggregated for the one or more storage resources.

4. The storage control apparatus according to claim 1,
wherein the predetermined timing is timing at which a total size of the backup data stored in the memory in association with a storage resource reaches or exceeds a threshold.

5. The storage control apparatus according to claim 1,
wherein the predetermined timing is timing at which a period set corresponding to the one or more storage resources has elapsed starting from storage in the memory of the backup data in association with the one or more storage resources.

6. The storage control apparatus according to claim 1,
wherein a plurality of buffers are provided in the memory for respective storage apparatuses out of the plurality of storage apparatuses, and
the processor stores first backup data that has a storage resource as a write destination in a first buffer corresponding to the storage resource and, when a write request for second backup data that has the storage resource as a write destination is received while the first backup data stored in the first buffer is being written into the storage resource, stores the second backup data in a second buffer corresponding to the storage resource.

7. A storage apparatus comprising:
a plurality of storage resources that are used to store backup data and for which power can be individually turned on and off;
a memory that stores the backup data when the power of a storage resource is off,
a processor that stores, when a write request for the backup data is received, the backup data in the memory so as to be associated with the storage resources and, at predetermined timing, issues an instruction for a write of the backup data stored in the memory; and
a controller that individually turns on the power of storage resources corresponding to the instruction, reads the backup data associated with the storage resources whose power has been turned on from the memory, writes the backup data into the storage resources, and turns off the power of the storage resources for which the write has been completed.

8. A non-transitory computer-readable storage medium storing a computer program that causes a computer to perform a procedure comprising:
storing, whenever a write request for backup data for a storage resource out of a plurality of storage resources, which are used to store the backup data and whose power can be individually turned on and off, has been received while the power of the storage resource is off, the backup data in a memory so as to be associated with the storage resource;
separately turning on, at predetermined timing, the power of one or more storage resources that are the write destinations of the backup data stored in the memory, out of the plurality of storage resources;
reading the backup data associated with the one or more storage resources whose power has been turned on from the memory and writing the backup data into the one or more storage resources; and
turning off the power of the one or more storage resources for which the writing has been completed.
